(19) United States
(12) Patent Application Publication
(10) Pub. No.: US 2022/0195562 A1
(43) Pub. Date: Jun. 23, 2022

(54) ALUMINUM ALLOY, ALUMINUM ALLOY WIRE, AND METHOD FOR PRODUCING ALUMINUM ALLOY

(71) Applicant: SUMITOMO ELECTRIC INDUSTRIES, LTD., Osaka-shi, Osaka (JP)

(72) Inventors: Rui IWASAKI, Osaka-shi (JP); Toru MAEDA, Osaka-shi (JP); Tetsuya KUWABARA, Osaka-shi (JP)

(73) Assignee: SUMITOMO ELECTRIC INDUSTRIES, LTD., Osaka-shi, Osaka (JP)

(21) Appl. No.: 17/598,846

(22) PCT Filed: Apr. 2, 2020
(86) PCT No.: PCT/JP2020/015139

§ 371 Date: Sep. 27, 2021

(30) Foreign Application Priority Data
May 29, 2019 (JP) 2019-100604

(51) Int. Cl. C22C 21/00; C22F 1/04; C21D 9/52

(52) U.S. Cl. CPC C22C 21/00; C21D 9/525; C22F 1/04

(57) ABSTRACT

An aluminum alloy having a composition including 0.1% by mass or more and 2.8% by mass or less of Fe; and 0.002% by mass or more and 2% by mass or less of Nd.

### TECHNICAL FIELD

The present disclosure relates to an aluminum alloy, an aluminum alloy wire, and a method for producing an aluminum alloy. The present application claims priority from Japanese Patent Application No. 2019-100604, which was filed on May 29, 2019, and all of the contents of the Japanese patent application are incorporated herein by reference.

### BACKGROUND ART

Patent Literature 1 discloses, as a conductor wire used for an electrical wire, a wire material composed of an aluminum alloy including Fe. Further, Patent Literature 1 discloses, as a method for producing this wire material, that a continuously cast rolled material composed of the aluminum alloy is subjected to wire drawing, and the obtained wire drawing material is softened.

### CITATION LIST

### Patent Literature

PTL 1: Japanese Patent Laying-Open No. 2010-067591

### SUMMARY OF INVENTION

A first aluminum alloy of the present disclosure has a composition including:

0.1% by mass or more and 2.8% by mass or less of Fe; and

0.002% by mass or more and 2% by mass or less of Nd.

A second aluminum alloy of the present disclosure has a composition including:

0.1% by mass or more and 2.8% by mass or less of Fe; and

0.002% by mass or more and 2% by mass or less of Nd,

with the balance being Al and unavoidable impurities.

An aluminum alloy wire of the present disclosure is made of the aluminum alloy of the present disclosure.

A method for producing an aluminum alloy of the present disclosure comprises:

producing a material composed of an aluminum alloy including of 0.1% by mass or more and 2.8% by mass or less of Fe and 0.002% by mass or more and 2% by mass or less of Nd; and

heat treating the material.

### BRIEF DESCRIPTION OF DRAWINGS

FIG. 1 is a diagram illustrating a method for measuring a maximum length of a compound including Al and Fe.

### DETAILED DESCRIPTION

### Problem to be Solved by the Present Disclosure

An aluminum alloy having excellent conductivity and higher strength is desirable.

The aluminum alloy wire described in Patent Literature 1 has a conductivity of 58% IACS or more and an elongation at break of 10% or more, but a tensile strength of 200 MPa or less. For example, for an ultrafine wire used for earphones and the like (for example, having a wire diameter of 0.1 μm or less), it is desirable to have excellent strength so that the wire does not break by sound vibration or the like. Therefore, an aluminum alloy having higher tensile strength and excellent strength while having high conductivity as described above is desirable. Further, an aluminum alloy having high elongation at break and excellent toughness is preferable.

In general, the larger the content of an added element in an alloy, the stronger the alloy tends to be. However, for a solid-solution-strengthening type of added element, the conductivity of the alloy tends to decrease as the content of the added element increases. This is because the solid solution amount of the added element with respect to the Al constituting the matrix increases. Even for an added element capable of precipitating, the conductivity of the alloy may decrease depending on the state of the precipitates. For example, if the precipitates are coarse, have agglomerated into agglomerates, or are continuous and long, the conductive path of the Al tends to be hindered, and the electrical resistance of the alloy tends to increase. As a result, the conductivity of the alloy decreases.

Therefore, it is an object of the present disclosure to provide an aluminum alloy and an aluminum alloy wire having excellent conductivity and high strength, and also to provide a method for producing an aluminum alloy capable of producing an aluminum alloy having excellent conductivity and high strength.

### Advantageous Effect of the Present Disclosure

The aluminum alloy of the present disclosure and the aluminum alloy wire of the present disclosure have excellent conductivity and high strength. The method for producing an aluminum alloy of the present disclosure can produce an aluminum alloy having excellent conductivity and high strength.

### DESCRIPTION OF EMBODIMENTS

First, the embodiments of the present disclosure will be listed and described.

(1) An aluminum alloy (hereinafter, sometimes referred to as Al alloy) according to a first aspect of the present disclosure has a composition including:

0.1% by mass or more and 2.8% by mass or less of Fe; and

0.002% by mass or more and 2% by mass or less of Nd.

The present inventors have obtained the knowledge that when Fe is included in the above-described range and Nd is also included in the above-described range, tensile strength is greatly improved and strength is excellent. The Al alloy of present disclosure is based on this knowledge.

A first Al alloy of present disclosure has excellent conductivity and high strength for the following reasons. One of the reasons is that an Al alloy including Fe and Nd in the above-described ranges typically has the following specific structure. In the specific structure, a matrix mainly composed of Al is composed of fine crystals, and a compound including Al and Fe (hereinafter, sometimes referred to as Fe—Al compound) is dispersed as fine particles in the fine crystal structure. In general, Fe—Al compounds, such as an intermetallic compound of Al and Fe, tend to grow in a coarse manner. However, Nd is considered to have an action of making the above-described compound into a fine precipitate. If the compound is fine, the growth of the crystals constituting matrix is suppressed, and the crystals of the matrix tend to be fine.

The Al alloy having the above-described specific structure has excellent strength due to an effect of an improvement in strength by strengthening of the grain boundaries of the fine crystals and an effect of an improvement in strength by dispersion strengthening of the fine Fe—Al compound. Further, such an Al alloy not only has excellent strength at room temperature (e.g., 25° C.), but also tensile strength is unlikely to decrease even at high temperature (e.g., 150° C.), and also has excellent heat resistance. Furthermore, if the above-described compound is fine, the compound tends not to serve as a starting point of cracking. Therefore, the Al alloy tends to have high elongation and also have excellent toughness.

If the Fe and Nd precipitate or the like and are not in solid solution in the matrix, the amount of Fe and Nd in solid solution with respect to the Al tends to decrease. Further, if the Fe—Al compound is fine, it is unlikely to impair the conductive path of the Al. Therefore, the Al alloy having the above-described specific structure has a smaller decrease in conductivity due to the solid solution and a smaller decrease in conductivity due to the above-described compound, and hence has excellent conductivity.

(2) The Al alloy according to the second aspect of the present disclosure has a composition including:

0.1% by mass or more and 2.8% by mass or less of Fe; and

0.002% by mass or more and 2% by mass or less of Nd;

with the balance being Al and unavoidable impurities.

A second Al alloy of present disclosure has excellent conductivity and high strength for the same reason as the first Al alloy described above. Further, the second Al alloy of present disclosure also has excellent heat resistance and toughness for the same reason as the first Al alloy described above.

In addition, the second Al alloy of present disclosure has two types of added elements, Fe and Nd. In such an Al alloy, the composition, heat treatment conditions, and the like can easily be adjusted in the production process. In this respect, the second Al alloy of present disclosure also has excellent production properties.

(3) As an example of the first Al alloy or the second Al alloy of the present disclosure, there can be mentioned a mode in which a content of Fe in the composition is 0.1% by mass or more and 2.4% by mass or less.

In this mode, it is easy to obtain the effect of an improvement in strength by dispersion strengthening of the Fe—Al compound. Further, in this mode, the compound is less likely to be coarse, and tends to be fine. As a result, the crystals constituting the matrix also tend to be fine.

(4) As an example of the first Al alloy or the second Al alloy of the present disclosure, there can be mentioned a mode in which a content of Nd in the composition is 0.01% by mass or more and 0.5% by mass or less.

In this mode, the Fe—Al compound is less likely to be coarse, and tends to be fine. As a result, the crystals constituting the matrix also tend to be fine. Further, in this mode, a decrease in conductivity due to containing the Nd as described layer is less likely to occur.

(5) As an example of the first Al alloy or the second Al alloy of the present disclosure, there can be mentioned a mode in which

the Al alloy has a structure including a matrix and a compound,

the matrix is a metal phase mainly composed of Al,

the compound is a compound including Al and Fe, and

in any cross section, the matrix has an average grain size of 0.1 μm or more and 5 μm or less.

In this mode, it can be said that the matrix is composed of fine crystals. Further, if the matrix has a fine crystal structure, the Fe—Al compound tends to be uniformly dispersed in the matrix. In such a mode, it is easier to obtain the effect of an improvement in strength by strengthening of the grain boundaries of the fine crystals and the effect of an improvement in strength by dispersion strengthening of the above-described compound.

(6) As an example of the Al alloy of (5), there can be mentioned a mode in which the average grain size is 0.3 μm or more and 5 μm or less.

In this mode, an appropriate amount of Fe—Al compound is likely to be present in the matrix, strength is excellent, and elongation is also excellent. Moreover, since there is not too much of the above-described compound, this mode also has excellent conductivity.

(7) As an example of the first Al alloy or the second Al alloy of the present disclosure, there can be mentioned a mode in which

the Al alloy has a structure including a matrix and a compound,

the matrix is a metal phase mainly composed of Al,

the compound is a compound including Al and Fe, and

in any cross section, the compound has an average major axis length of 750 nm or less.

In this mode, it can be said that the Fe—Al compound has a short average major axis length and is fine. As a result, the crystals constituting the matrix also tend to be fine.

(8) As an example of the Al alloy of (7), there can be mentioned a mode in which the average major axis length is 500 nm or less.

In this mode, the Fe—Al compound is finer. Therefore, the crystals constituting the matrix also tend to be finer.

(9) As an example of the Al alloy of (7) or (8), there can be mentioned a mode in which the compound has an average aspect ratio of 3.5 or less.

In this mode, it can be said that the aspect ratio of the Fe—Al compound is small. The smaller the aspect ratio, the closer the above-described compound is qualitatively to a spherical shape, and the more likely it is that the compound disperses uniformly in the matrix. Further, an Fe—Al compound having a short average major axis length and a small aspect ratio is less likely to impair the conductive path of the Al. In addition, such an Fe—Al compound tends not to serve as a starting point of cracking.

(10) As an example of the Al alloy of (9), there can be mentioned a mode in which the compound has an average aspect ratio of 2.5 or less.

In this mode, the aspect ratio of the Fe—Al compound is smaller. Therefore, in this mode, the effects that the compound tends to be uniformly dispersed in the matrix, the compound is less likely to impair the conductive path, and the compound tends not to serve as a starting point of cracking, are more likely to be obtained.

(11) As an example of the Al alloy of any one of (7) to (10), there can be mentioned a mode in which in any cross section, in a square measurement area with sides of 5 μm, an average number of the compound present in the measurement area is 100 or more and 5000 or less.

In this mode, it can be said that there is not too much of the fine Fe—Al compound having an average major axis length of 750 nm or less, and an appropriate amount is present in the matrix. In such a mode, the effect of an improvement in strength by dispersion strengthening of the fine compound and the effect of an improvement in strength by strengthening the grain boundaries of the fine crystals. Therefore, this mode not only has excellent strength but also excellent elongation. In addition, this mode also has excellent conductivity because the amount of Fe—Al compound is not too much.

(12) As an example of the Al alloy of any one of (5) to (II), there can be mentioned a mode in which Nd satisfies at least one of being in solid solution in the compound and being present at a grain boundary between a crystal of the matrix and the compound.

In this mode, it is considered that the action of the Nd making the Fe—Al compound into a fine precipitate can be appropriately obtained.

(13) As an example of the first Al alloy or the second Al alloy of the present disclosure, there can be mentioned a mode in which

a conductivity at room temperature is 58% IACS or more,

a tension strength at room temperature is more than 200 MPa,

an elongation at break at room temperature is 7.5% or more.

In this mode, it can be said that the conductivity, tensile strength, and elongation at break are all high. Such an above-described mode can be suitably used in applications where high conductivity, high strength, and high toughness are desired.

(14) As an example of the Al alloy of (13), there can be mentioned a mode in which a tensile strength at 150° C. is 150 MPa or more.

This mode has high tensile strength even at a high temperature such as 150° C. and excellent heat resistance.

(15) An Al alloy wire according to one aspect of the present disclosure is made of the Al alloy of any one of (1) to (14).

The Al alloy wire of the present disclosure has, for the same reasons as the above-described first Al alloy, excellent conductivity and high strength.

(16) As an example of the Al alloy wire of the present disclosure, there can be mentioned a mode in which a wire diameter is 0.1 mm or more and 5 mm or less.

This mode can be suitably used for a conductor or the like.

(17) A method for producing an Al alloy according to one aspect of the present disclosure comprises:

producing a material composed of an aluminum alloy including of 0.1% by mass or more and 2.8% by mass or less of Fe and 0.002% by mass or more and 2% by mass or less of Nd; and

heat treating the material.

The method for producing an Al alloy of the present disclosure can produce an Al alloy having excellent conductivity and high strength. One of the reasons for this is that by precipitating the Fe—Al compound or adjusting the size of the Fe—Al compound by heat treatment, it is possible to form the above-described specific structure, that is, a structure in which a fine Fe—Al compound is dispersed in a fine crystal structure. In particular, due to the action of the Nd, the Fe—Al compound tends to be finer than when the Nd content is less than 0.002% by mass. If the above-described compound is fine, the growth of the crystals constituting the matrix is suppressed. As a result, the matrix tends to have a fine crystal structure. The Al alloy having the above-described specific structure also has excellent heat resistance and toughness, as described above. Therefore, the method for producing an Al alloy of the present disclosure can produce an Al alloy having excellent conductivity and high strength, as well as excellent heat resistance and toughness.

(18) As an example of the method for producing an Al alloy of the present disclosure, there can be mentioned a mode in which producing the material includes producing a thin strip material or a powder by quenching a molten metal composed of the aluminum alloy at a cooling rate of 10,000° C./sec or more.

This mode can easily produce an Al alloy of various shapes and sizes and having the above-described specific fine structure. The details will be described later (in particular, refer to [Method for producing Al alloy], (Material preparation step), and <Solidification step>).

### Details of Embodiments of Present Disclosure

Hereinafter, an embodiment of the present disclosure will be described in detail. In the following description, unless stated otherwise, the content of the elements in the Al alloy is in terms of mass ratio when the Al alloy is 100% by mass.

[Aluminum alloy]

(Overview)

The aluminum alloy (Al alloy) of the embodiment includes added elements, is an alloy based on Al, and includes more than 50% by mass of Al. In particular, the Al alloy of the embodiment has a composition including 0.1% by mass or more and 2.8% by mass or less of Fe and 0.002% by mass or more and 2% by mass or less of Nd. The Al alloy of the embodiment has, typically, has a structure in which a matrix mainly composed of Al has a fine crystal structure and Fe is dispersed in the matrix as fine particles composed of an Fe—Al compound. It is considered that the compound becomes finer by the action of the Nd. The Al alloy of such an embodiment has excellent conductivity and a high strength. For example, the Al alloy of the embodiment has, at room temperature (e.g., 25° C.), a conductivity of 58% IACS or more and a tensile strength of more than 200 MPa.

Hereinafter, a more detailed description will be given.

(Composition)

The Al alloy of the embodiment contains Fe and Nd as essential added elements. As a representative example, the Al alloy of the embodiment has a composition including 0.1% by mass or more and 2.8% by mass or less of Fe, 0.002% by mass or more and 2% by mass or less of Nd, with the balance being Al and unavoidable impurities. For an Al alloy having the two types of added elements, Fe and Nd, the composition, heat treatment conditions, and the like can be easily adjusted during the production process. Therefore, this Al alloy also has excellent production properties.

<Fe (iron)>

The Fe satisfies the following conditions (1) and (II).

(I) The amount of Fe in solid solution (equilibrium state) with respect to Al under conditions of 660° C. and 1 atm is 0.5% by mass or less.

(II) Fe forms a compound with Al. Among the binary intermetallic compounds of Al and Fe, the melting point of the compound having the lowest element ratio of Fe (e.g., Al₁₃Fe₄) is 1100° C. or higher.

In an Al alloy that includes Fe satisfying the above conditions (I) and (II) in the above-described range, the Fe can be in solid solution in the matrix by quenching the molten metal during the production process as described later, for example. Further, for example, if a material in which Fe is in solid solution is subjected to a heat treatment, the Fe can be precipitated from the matrix as a compound including Al and Fe. This is because the compound has a high melting point and excellent stability, and is therefore easily produced by a heat treatment. In addition, the above compound is generally harder than Al. Therefore, the Al alloy of the embodiment can be used as one of the strengthening structures of an alloy obtained by dispersion strengthening (precipitation strengthening) due to the compound.

When the content of Fe is 0.1% by mass or more, Fe is mainly present as a compound with Al (as an Fe—Al compound), so that the effect of an improvement in strength by dispersion strengthening of the compound can be obtained. Therefore, the Al alloy has excellent strength. When the Fe content is 0.3% by mass or more, and further 0.5% by mass or more, the strength of the Al alloy tends to be higher. When the Fe content is 1.0% by mass or more, 1.2% by mass or more, and 1.5% by mass or more, the strength of the Al alloy tends to be even higher. The reason for this is that the amount of the above compound tends to increase, and therefore the effect of an improvement in the strength of the compound by dispersion strengthening tends to be obtained.

When the Fe content is 2.8% by mass or less, the Fe—Al compound tends not to become coarse, and tends to be fine. If the compound is fine, the following effects (i) to (v) tends to be obtained. Due to the effects (i) to (iv), the Al alloy has excellent strength. Further, due to the effect (v), the Al alloy has excellent conductivity.

(i) The effect of an improvement in strength by dispersion strengthening of the fine Fe—Al compound tends to be obtained.

(ii) The number of coarse Fe—Al compound is small. Therefore, embrittlement of the Al alloy tends to be suppressed.

(iii) A fine Fe—Al compound tends not to serve as a starting point of cracking. Therefore, the Al alloy does not easily break. Further, the Al alloy has excellent elongation, has excellent flexibility because it bends and the like easily, and has excellent fatigue strength because it does not easily break due to repeated bending. In addition, rigidity against bending is suppressed from becoming too high, and springback can also be easily reduced.

(iv) The fine Fe—Al compound suppresses growth of the crystals constituting the matrix. Therefore, the crystals tend to be fine. As a result, the effect of an improvement in strength due to strengthening of the grain boundaries of the fine crystals tends to be obtained.

(v) The fine Fe—Al compound tends not to hinder the conductive path of Al.

Further, when the Fe content is 2.8% by mass or less, it is easier to prevent there being too much of the Fe—Al compound. Therefore, it is easier to prevent hinderance of the conductive path of Al due to there being too much of the compound present. In addition, the amount of Fe in solid solution with respect to Al tends to decrease, and the purity of the Al in the matrix tends to increase. The Al alloy has excellent conductivity because there the decrease in conductivity due to the above compound and the decrease in conductivity due to the solid solution are small. The Al alloy of the embodiment does not improve strength through increasing the amount of Fe, but improves strength by the above-described effects (i), (iv) and the like. Therefore, the Al alloy of the embodiment can suppress a decrease in conductivity due to an increase in Fe and can secure high conductivity.

When the Fe content is 2.7% by mass or less, and further 2.6% by mass or less and 2.5% by mass or less, the conductivity of the Al alloy tends to be higher. When the Fe content is 2.4% by mass or less, and further 2.2% by mass or less, the conductivity of the Al alloy tends to be higher. The reasons for this include, for example, the fact that there is only a small amount or substantially no coarse Fe—Al compound, the fact that there tends to be an appropriate amount of the compound, and the fact that the purity of the Al can be easily increased.

In addition, the melting point of Fe is higher than the melting point of Al. Therefore, the Al and the Fe can be easily separated. In this respect, the Al alloy of the embodiments has excellent recyclability.

<Nd (Neodymium)>

The Nd is considered to have an action of making the compound including Al and Fe into a fine precipitate. Specifically, the Nd is considered to have an action of stabilizing the compound in terms of its energy. The details of the stabilization mechanism are unknown, but the fact that the compound becomes thermodynamically stabile is shown from a phase diagram calculation. Since the compound generated in the initial stage stabilizes at a fine size, adjacent compounds tend not to coalesce with each other. As a result, it is considered that coarse growth of the compound due to coalescence is suppressed. Additionally, it is considered that the compound exists as a fine precipitate in the Al alloy in the final product state after undergoing plastic working or a heat treatment.

When the Nd content is 0.002% by mass or more, the Fe—Al compound tends to be finer than when the Nd content is less than 0.002% by mass. If the compound is fine, due to the above-described effects (i) to (v), the Al alloy has high strength while having excellent conductivity.

When the Nd content is 0.005% by mass or more, and further 0.008% by mass or more, the strength of the Al alloy tends to increase. When the Nd content is 0,01% by mass or more, and further 0.05% by mass or more, the strength of the Al alloy tends to increase even more. The reason for this is considered to be that the action by the Nd of miniaturizing the Fe—Al compound occurs more reliably.

When the Nd content is 2% by mass or less, compounds other than the precipitate composed of the Fe—Al compound are less likely to be produced in the production process. Compounds other than the Fe—Al compound are compounds composed of a composition having a relatively low melting point. Examples of such compounds include intermetallic compounds that do not include Fe, but do include Nd and Al, and have an Nd content of more than 50 atomic % (hereinafter, referred to as “low melting point compounds”). A precipitate composed of the low melting point compound tends to grow grains due to the heat of working during plastic working and the heating during a heat treatment. Therefore, the size of the low melting point compound is generally larger than the size of a precipitate composed of the Fe—Al compound. In the Al alloy of the embodiment, the low melting point compound is less likely to form, so that the decrease in strength due to a coarse precipitate is suppressed. Therefore, the Al alloy has excellent strength. Further, since there is not too much Nd, the decrease in the conductivity of the Al alloy is suppressed. The reason for this is that the amount of Al that does not contribute to ensuring good conductivity tends to decrease. That is, the amount of Al forming the low melting point compound tends to decrease. Further, impairment of the conductive path of Al by the low melting point compound tends to be prevented. Therefore, the Al alloy has excellent conductivity. Furthermore, the Al alloy also has excellent elongation. The reason for this is that although the low melting point compound can serve as the starting point of cracking, it is difficult for such a low melting point compound to form.

When the Nd content is 1.5% by mass or less, and further 1.0% by mass or less and 0.8% by mass or less, the Al alloy tends to have high conductivity while having high strength. When the Nd content is 0.5% by mass or less, and further 0.3% by mass or less, the Al alloy tends to have even higher conductivity while having high strength. The reason for this is that it is harder for the above-described low melting point compound to form.

Nd satisfies, typically, at least one of being in solid solution in the compound including Al and Fe and being present at a grain boundary between a crystal of the matrix and the compound. In the former case, the Nd is considered to exist as, typically, a compound or the like that includes Al, Fe, and Nd. In the latter case, the Nd is, typically, an intermetallic compound with Al, and is considered to exist as an intermetallic compound having a high melting point, for example, Al₄Nd (melting point 1235° C.). Since the high melting point intermetallic compound has a sufficiently low Nd content as compared with the above low melting point compound, it is considered that a composition having a high melting point tends to be maintained. Further, the intermetallic compound having a high melting point mainly exists as a fine precipitate, and so an effect of improving the strength by precipitation strengthening can be expected.

If the Nd is present in the Fe—Al compound or at the grain boundary, it is considered that the action by the Nd of miniaturizing the Fe—Al compound is appropriately produced. Such an Al alloy can easily obtain the above-described effects (i) to (v). Further, this Al alloy has a small solid solution amount of Nd dissolved in the Al, and it can be said to have a high Al purity. From these facts, this Al alloy has high strength while having excellent conductivity.

In addition, the melting point of Nd is lower than the melting point of Fe. Therefore, the Al alloy has excellent production properties in that it is easy to produce a molten metal in the production process. The low eutectic temperature of Nd and Al is also advantageous from a production perspective.

<Other Added Elements>

The Al alloy of the embodiment may include an element other than Fe and Nd as an added element. Examples of the element other than Fe and Nd include Cr (chromium), Ni (nickel), Co (cobalt), Ti (titanium), W (tungsten), Sc (scandium), Zr (zirconium), Nb (niobium), Hf (hafnium), rare earth elements (excluding Nd), B (boron), C (carbon) and the like. Cr, Ni, Co, and Ti (hereinafter referred to as a “first element”) can be expected to have an action similar to that of Fe, that is, an action mainly of improving strength. Co, W, Sc, Zr, Nb, Hf, rare earth elements, B, C (hereinafter referred to as a “second element”) can be expected to have the same action as Nd, that is, an action of miniaturizing the Fe—Al compound. This Al alloy includes Fe, Nd, and the elements listed above, with a balance composed of Al and unavoidable impurities. As for the content of the first element, for example, the total amount of Fe and the first element satisfies the above-described Fe content range. As for the content of the second element, for example, the total amount of Nd and the second element satisfies the above-described Nd content range.

The content of these added elements here is the amount contained in the Al alloy. In the production process, the raw material (typically, aluminum bullion) may include an element of the same type as the added element as an impurity. In this case, the amount of the added element added to the raw material may be adjusted so that the content of each added element in the Al alloy satisfies the above-described range.

<Solid Solution Amount>

In the Al alloy of the embodiment, the smaller the amount of the added element in solid solution with respect to Al, the better the conductivity is, which is preferable. For example, the solid solution amount of Fe is preferably 0.5% by mass or less, more preferably 0.2% by mass or less, with respect to 100% by mass of the matrix. The solid solution amount here is the amount of Fe contained in the portion of the Al that does not constitute the compound (precipitate) but does constitute the matrix crystal. When the solid solution amount of Fe is 0.5% by mass or less, the purity of the Al in the matrix is high and the conductivity is excellent. Further, it can be said that the smaller the solid solution amount of Fe, the more Fe is precipitated as the Fe—Al compound. Therefore, the effect of an improvement in the strength of the Fe—Al compound by dispersion strengthening can be obtained satisfactorily.

<Impurities>

Examples of impurities in the Al alloy of the embodiment include Si (silicon), Cu (copper), O (oxygen), and the like. The smaller the total content of impurities, the better the strength of the Al alloy tends to be. The reason for this is that a compound including an element that is an impurity tends to be formed, and the inclusion of such a compound can cause a decrease in strength. Further, the smaller the total content of impurities, the better the conductivity of the Al alloy tends to be. The reason for this is that the solid solution amount of the elements that are impurities tends to be smaller with respect to Al.

The total content of the impurities is, for example, 0.2% by mass or less. When the total content is 0.1% by mass or less, and further 0.05% by mass or less, strength and conductivity tend to increase. For example, if a raw material having a high Al content (purity) is used, this total content tends to be low.

(Structure)

The Al alloy of the embodiment typically has a structure that includes a matrix mainly composed of Al and a compound that includes Al and Fe. The Fe—Al compound (which may include Nd) is dispersed in matrix. The Al alloy of such an embodiment can obtain the effect of improving strength due to the dispersion strengthening of the compound and the effect of providing a high conductivity due to the small solid solution amount of Fe and Nd in the matrix. Such an Al alloy tends to have a good balance between a high tensile strength and a high conductivity.

<Matrix>

The matrix is the main metal phase excluding precipitates such as compounds that include Al and Fe. The matrix is a metal phase mainly composed of Al, and typically is composed of 98% by mass or more of Al, an element that dissolves in Al, and unavoidable impurities (the matrix is 100% by mass). The higher the Al content in the matrix (e.g., 99.0% by mass or more, and further 99.5% by mass or more), the smaller the solid solution amount of the added elements such as Fe and Nd. Further, it can be said that Fe is substantially present as a precipitate. Such an Al alloy can satisfactorily obtain the effect of improving strength due to the above-described dispersion strengthening and the effect of providing high conductivity by reducing the solid solution amount. The composition of the raw material and the production conditions, particularly the heat treatment conditions and the like, may be adjusted so that the Al content in the matrix is within a predetermined range.

<Matrix Crystal Grains>

In any cross section of the Al alloy, the matrix has an average grain size of 0.1 μm or more and 5 μm or less.

As used herein, the average crystal grain size of the matrix is defined as the diameter of a circle having an area equivalent to the cross-sectional area of each crystal grain in the above-mentioned cross section, and the grain size of a plurality of crystal grains is averaged. The details of the measurement method will be described in Test Example 1.

When the matrix has an average crystal grain size of 5 μm or less, the crystal can be said to be fine. Due to the small size of the crystal, there are many grain boundaries. If there are many grain boundaries, the slip surface tends to be discontinuous via the grain boundaries. Therefore, the resistance to slip is increased. This improvement in resistance strengthens the grain boundaries. In the Al alloy having a crystal structure in which matrix is fine as described above, the grain boundary reinforcement of the crystal can be utilized as one of the reinforcement structures of the alloy. Further, if the matrix has a fine crystal structure, the Fe—Al compound tends to uniformly disperse in the matrix. Therefore, an Al alloy in which the matrix has a fine crystal structure tends to also obtain the effect of improving strength by dispersion strengthening of the above-described compound, and has better strength.

When the matrix has an average crystal grain size of 4.8 μm or less, and further 4.0 μm or less and 3.8 μm or less, the Al alloy has even better strength. When the average crystal grain size is 2.5 μm or less, and further 2.0 μm or less and 1.5 μm or less, the Al alloy has still even better strength. The reason for this is that the effect of an improvement in strength can be more easily obtained.

When the matrix has an average crystal grain size of 0.1 μm or more, it can be said that the crystal is not too small. Therefore, even if the Fe—Al compound is precipitated at the grain boundary, the precipitation amount tends not be too much. As a result, it is considered that impairment of the conductive path of Al due to there being too much of the compound tends to be prevented, and conductivity tends to be increased. Further, it is considered that the breakage due to there being too much of the compound tends to be prevented, and elongation tends to be increased. When the average crystal grain size is 0.2 μm or more, and further 0.3 μm or more and 0.5 μm or more, the conductivity and elongation tend to be higher.

<Compound>

<<Size>>

The smaller the compound that includes Al and Fe (and which may include Nd) is, the easier it is to obtain the above-described effects (i) to (vi). For example, in any cross section of the Al alloy, the compound has an average major axis length of 750 nm or less.

As used herein, the average major axis length of the compound is a value obtained by extracting a plurality of the Fe—Al compounds in the above-described cross section, setting the maximum length of each compound as the major axis length, and averaging the plurality of the major axis lengths. The details of the measurement method will be described in Test Example 1.

When the Fe—Al compound has an average major axis length of 750 nm or less, the compound is not continuous in the matrix and can be said to be short (small). Such a compound tends to be isolated in the matrix, that is, tends to be dispersed. Therefore, the strength of the Al alloy is increased by the above-described effect (i). Further, if the compound is fine, the above-described effects (ii) to (v) tend to be obtained. Therefore, this Al alloy has excellent strength not only at room temperature but also at high temperature, and also has excellent conductivity.

When the Fe—Al compound has an average major axis length of 700 nm or less, and further 650 nm or less and 600 nm or less, the Al alloy has even better strength and conductivity. When the average major axis length is 500 nm or less, and further 300 nm or less, the Al alloy has still even better strength and conductivity. The reason for this is that since the above-described compound is finer, the above-described effects (i) and (v) in particular are more likely to be obtained.

No lower limit is set in particular for the average major axis length of the Fe—Al compound. Considering production properties and the like, the average major axis length is, for example, 10 nm or more, and further 15 nm or more.

<<Shape>>

The compound including Al and Fe (and which may include Nd) preferably has a shape close to a spherical shape in addition to being fine as described above. The closer the compound is to a spherical shape, the more likely it is that the following effects are obtained. Due to the following effects (a) to (c), the Al alloy has excellent strength and conductivity.

(a) The compound tends to be uniformly dispersed in the matrix.

(b) The compound tends not to serve as a starting point of cracking.

(c) The compound tends not to impair the conductive path of Al.

In addition, because the compound tends not to serve as a starting point of cracking, the Al alloy also has excellent elongation.

Specifically, in any cross section of the Al alloy, the shape of the Fe—Al compound is preferably a shape in which a difference between the major axis length described above and a minor axis length described later is small. Quantitatively, in the cross section, the compound has an average aspect ratio of 3.5 or less.

As used herein, the average aspect ratio of the compound is a value obtained by averaging a plurality of aspect ratios determined as follows. In the cross section, a plurality of the Fe—Al compounds are extracted, and the major axis length and the minor axis length of each compound are determined. The ratio of the major axis length to the minor axis length (major axis length/minor axis length) is defined as the aspect ratio of each compound. The major axis length of each compound is the maximum length in the cross section as described above. The minor axis length of each compound is the maximum value of the length in the direction orthogonal to the direction along the major axis length in each compound. The details of the measurement method will be described in Test Example 1.

It can be said that the smaller the aspect ratio, qualitatively, the closer the compound is to a spherical shape. When the average aspect ratio of the Fe—Al compound is 3.5 or less, it can be said that the compound is closer to a spherical shape than an elongated shape such as a needle shape. Therefore, this Al alloy tends to obtain the above-described effects (a) to (c), and has excellent strength and conductivity.

When the average aspect ratio of the Fe—Al compound is 3.0 or less, and further 2.8 or less, the Al alloy has better strength and conductivity. When the average aspect ratio is 2.5 or less, and further 2.0 or less, the Al alloy has even better strength and conductivity, and also tends to have high elongation. The reason for this is that since the compound is nearly spherical, the above-described effects (a) to (c) are more likely to be obtained.

It can be said that the closer the average aspect ratio of the compound is to 1, the anisotropy of the shape of the compound tends to be smaller or substantially nonexistent. Such a compound tends to disperse even more uniformly in the matrix.

<<Abundance>>

The compound including Al and Fe (which may include Nd) is preferably present in an appropriate amount in the matrix in addition to being fine as described above. When the compound is appropriately present, the above-described effects (i) and (iv) in particular are likely to be obtained. Further, it is easier to obtain effects such as a reduction in the occurrence of cracks due to too much of the compound and suppressing embrittlement of the Al alloy. As a result, the Al alloy has excellent strength and conductivity. Further, since the occurrence of cracks can be reduced, the Al alloy also has excellent elongation.

Quantitatively, an average density of the Fe—Al compound is, in any cross section of the Al alloy, 100 or more and 5000 or less.

As used herein, the average density of the Fe—Al compound is the average number of the compound present in the following measurement area in any cross section of the Al alloy. Specifically, in any cross section of the Al alloy, in a square measurement area with sides of 5 μm, the number of the compound present in the measurement area is determined. The average density of the compound is a value obtained by averaging the number of the compound in a plurality of the measurement areas. The details of the measurement method will be described in Test Example 1.

When the average density of the Fe—Al compound is 100 or more, the fine Fe—Al compound is appropriately present, and the above-described effects (i), (iv), and the like are more likely to be obtained. Therefore, the Al alloy has excellent strength. When the average density is 150 or more, further 200 or more, and 300 or more, the Al alloy has even better strength. When the average density is 400 or more, further 450 or more, 500 or more, or 600 or more, the Al alloy has still even better excellent strength. The reason for this is that the above-described effects (i), (iv), and the like are more likely to be obtained. Moreover, such an Al alloy also has excellent heat resistance.

When the average density of the Fe—Al compound is 5000 or less, the Al alloy has excellent strength due to the above-described effects (i), (iv), and the like, and also has excellent conductivity and elongation because there is not too much of the compound. When the average density is 4500 or less, and further 4000 or less and 3500 or less, the Al alloy tends to have even higher conductivity and elongation. When the average density is 3000 or less, and further 2800 or less, the Al alloy tends to have still even higher conductivity and elongation.

In an arbitrary cross section of the Al alloy, if the average density of the Fe—Al compound satisfies the above-described range, it can be said that the anisotropy of the abundance of the compound is small or substantially nonexistent. In such an Al alloy, it can be said that the compound is uniformly dispersed.

<Mechanical Properties>

<<Tensile Strength>>

The Al alloy of the embodiment has, for example, a property (A), namely, a tensile strength at room temperature (e.g., 25° C.), of more than 200 MPa. An Al alloy having such a tensile strength of more than 200 MPa has a higher strength than, for example, the Al alloy wire described in Patent Literature 1. The Al alloy of the embodiment has a specific composition of including Nd in addition to Fe. Therefore, it is possible to have the above-described specific structure. In the Al alloy of such an embodiment, the above-described effects (i) and (iv) in particular are obtained, and therefore the tensile strength is improved. When this tensile strength is 220 MPa or more, further 240 MPa or more, and 250 MPa or more, the Al alloy has even better strength. There is no particular upper limit on the tensile strength.

<<Elongation at Break>>

The Al alloy of the embodiment has, for example, a property (B), namely, an elongation at break at room temperature (e.g., 25° C.), of 7.5% or more. If Fe precipitates, the matrix tends to exhibit ductile behavior. Further, if the Fe—Al compound is fine, the Fe—Al compound tends not to serve as a starting point of cracking. Such an Al alloy tends to have high elongation.

If the elongation at break is 7.5% or more, the Al alloy has excellent toughness at room temperature. An Al alloy having excellent strength and toughness at room temperature has, for example, excellent plastic workability at a cold temperature. As a result, this Al alloy can be used, for example, as a material for cold working. If the elongation at break is 8% or more, further 10% or more, 12% or more, and particularly 15% or more, the Al alloy has even better toughness. The upper limit of the elongation at break is not particularly set.

<<Heat Resistance>>

The Al alloy of the embodiment has, for example, a property (C), namely, a tensile strength at 150° C. of 150 MPa or more. By having the specific structure described above, the tensile strength tends not to decrease even at a high temperature of 150° C., and hence tensile strength tends to be high. One of the reasons for this is that in an Al alloy having the above-described specific structure, the fine Fe—Al compound has a high melting point as described above, and therefore the Fe—Al compound tends not to grow in a coarse manner even at a high temperature (tends not to grow in a needle shape), and a fine state tends to be maintained. When the compound is fine even at a high temperature, the crystals constituting the matrix tends to be maintained in a fine state. As a result, the Al alloy having the above-described specific structure has excellent strength through the effect of an improvement in strength due to the dispersion strengthening of the fine compound and the effect of an improvement in strength due to strengthening of the grain boundaries of the fine crystals even at a high temperature.

When the tensile strength at 150° C. is 150 MPa or more, it can be said that the Al alloy has excellent strength even at a high temperature, that is, has excellent heat resistance. When the tensile strength at 150° C. is 160 MPa or more, and further 170 MPa or more and 180 MPa or more, the Al alloy has even better heat resistance.

The tensile strength at 150° C. is typically equal to or less than the tensile strength at room temperature. Therefore, the closer the tensile strength at 150° C. is to the tensile strength at room temperature, the better the heat resistance of the Al alloy.

<Electrical Properties>

The Al alloy of the embodiment has, for example, a property (D), namely, a conductivity at room temperature (e.g., 25° C.) of 58% IACS or more. When this conductivity is 58% IACS or more, the Al alloy has excellent conductivity. Such an Al alloy can be suitably used for a conductor or the like. When this conductivity is 59% IACS or more, and further 60% IACS or more, the Al alloy has even better excellent conductivity.

This conductivity is preferably as close to 65% IACS as possible, which is the theoretical value of the Al conductivity.

The Al alloy of the embodiment can, for example, satisfy two or more properties selected from the group consisting of the above-described properties (A), (B), (C), and (D). It is preferable to satisfy three or more properties, and further preferable to satisfy four properties. Such an Al alloy can be suitably used in applications where high conductivity, high strength, high toughness, and heat resistance are desired.

<Method for Adjusting Properties>

The average major axis length, average aspect ratio, average density, tensile strength, elongation at break, and conductivity of the Fe—Al compound can be changed by, for example, adjusting the Fe content, Nd content, and production conditions (e.g., heat treatment conditions and the like). For example, when Fe is large in the above-described range, the average major axis length, the average aspect ratio, and the average density tend to increase. The opposite tends to occur when Fe is small in the above-described range. Further, for example, when Fe is large in the above-described range, the tensile strength tends to be high. When Fe is small in the above-described range, the conductivity and elongation at break tend to increase.

[Applicable Modes of the Al Alloy]

The Al alloy of the embodiment can take various shapes and sizes by subjecting it to various processes (e.g., plastic working, cutting, and the like) in the production process. For example, the Al alloy of the embodiment may be a solid substance such as a wire rod, a bar or a plate, a hollow body such as a pipe, or another mode. The Al alloy of such an embodiment can be used as a metal material for various purposes. In particular, the Al alloy of the embodiment has excellent conductivity and high strength, and therefore can be suitably used for a conductor. Further, since the Al alloy of the embodiment has excellent heat resistance, it can be used as a metal material for applications where the usage environment can be not only room temperature but also a high temperature (e.g., 150° C.).

<Aluminum Alloy Wire>

The Al alloy wire of the embodiment is composed of the Al alloy of the embodiment. The Al alloy wire of the embodiment is typically used in the state of a single wire, a stranded wire, or a compression stranded wire. The stranded wire is made by twisting a plurality of Al alloy wires. The compression stranded wire is made by compression-molding the stranded wire into a predetermined shape.

<<Shape>>

The cross-sectional shape of the Al alloy wire of the embodiment can be appropriately selected according to the application and the like. For example, the cross-sectional shape may be a circle (round line), a rectangle (flat line), a polygon such as an ellipse or a hexagon (irregular line). The Al alloy wire constituting the strand of the compression stranded wire has a cross-sectional shape as if a circle were crushed. The cross-sectional shape of the Al alloy wire can be changed according to, for example, the shape of a wire drawing die, the shape of a die for compression molding, and the like.

<<Size>>

The size (cross-sectional area, wire diameter, and the like) of the Al alloy wire of the embodiment can be appropriately selected according to the application and the like. As an example of the Al alloy wire of the embodiment, the wire diameter is 0.01 mm or more and 5 mm or less. The wire diameter here is, in the case of the above-described round wire, the diameter, and in the case of the above-described flat wire or irregular wire, the diameter of the minimum circle including the cross-sectional shape. Al alloy wires having a wire diameter in the above-described range can be used, for example, as conductor wires.

When the Al alloy wire of the embodiment is used as an electrical wire conductor included in various wire harnesses such as automobile wire harnesses, the wire diameter may be about 0.2 mm or more and 1.5 mm or less. When the Al alloy wire of the embodiment is used as an electrical wire conductor for constructing the wiring structure of a building or the like, the wire diameter may be about 0.2 mm or more and 3.6 mm or less. When the Al alloy wire of the embodiment is used for a signal wire of an earphone or the like or a conductor wire of a magnet wire, the wire diameter may be 0.01 mm or more and 0.5 mm or less. In particular, even if the wire diameter is 0.1 mm or less, since the wire is composed of the Al alloy of the embodiment, this ultrafine wire has excellent strength and is unlikely to break during use.

<Stranded Wire>

In the stranded wire (which may be a compressed stranded wire) that includes the Al alloy wire of the embodiment as a strand, the number of twists, the twist pitch, the compressed shape, and the like can be appropriately selected.

<Electrical Wire>

The Al alloy wire of the embodiment and the stranded wire (which may be a compressed stranded wire) including the Al alloy wire of the embodiment can be suitably used for a conductor wire in which high strength is particularly desired. The conductor wire may be a bare wire having no insulating coating or a coated electrical wire having an insulating coating. An appropriate insulating material can be used as the constituent material of the insulating coating. Further, the conductor wire can be an electrical wire with a terminal having a terminal at the end of the conductor wire of a coated electrical wire. Electrical wires with terminals can be used for wire harnesses installed in automobiles, airplanes, and the like, wire harnesses used for industrial robots, and the like. Known terminals such as crimp terminals and solder terminals can be used.

[Method for Producing Al Alloy]

(Overview)

The Al alloy of the embodiment can be produced, for example, by a method for producing the Al alloy of the embodiment (hereinafter, may be referred to as “the present production method”) including the following steps.

(Material Preparation Step)

A material composed of an aluminum alloy including 0.1% by mass or more and 2.8% by mass or less of Fe and 0.002% by mass or more and 2% by mass or less of Nd is produced.

(Heat Treatment Step)

The above material is subjected to a heat treatment.

In the present production method, an Al alloy having a specific structure in which the fine Fe—Al compound is dispersed in a fine crystal structure is obtained by heat treating a material that includes Fe and Nd. The Fe content range in the present production method exceeds the solid solution limit for Al (room temperature, 1 atm). Therefore, if the heat treatment is performed under conditions in which the above-described compound is easily precipitated, the compound can be precipitated and the size of the compound can be adjusted. In particular, due to the action of the Nd, the compound tends to become a fine precipitate. For example, after the heat treatment, the average major axis length of the compound can be 750 nm or less (see the above section <Compound> <<Size>>). In addition, the fineness of the compound suppresses the growth of the crystals constituting the matrix. As a result, the matrix tends to have a fine crystal structure. For example, the average crystal grain size of the matrix after the heat treatment can be set to 5 μm or less (see the above section <Matrix crystal grains>).

The Al alloy having the above-described specific structure has excellent strength while also having excellent conductivity due to the effects (i) to (v) described above. The reason why the Al alloy has excellent conductivity is also because the precipitation of the Fe—Al compound reduces the solid solution amounts of the Fe and Nd in the matrix and increases the purity of the Al. When plastic working is performed before the heat treatment, the reason for the Al alloy having excellent conductivity is also because the working strain can be removed by the heat treatment. For example, the present production method can produce an Al alloy having a conductivity of 58% IACS or more and a tensile strength of more than 200 MPa at room temperature. Further, the present production method can produce an Al alloy also having excellent heat resistance and toughness because the Al alloy has the above-described specific structure. In particular, since a heat treatment is performed, the present production method easily increases the elongation of the Al alloy.

Each of these steps will now be described below.

(Material Preparation Step)

The material composed of the Al alloy including Fe and Nd may have various shapes and sizes. For example, a thin strip material or powder composed of the Al alloy may be produced, and the thin strip material or powder may be used to produce a molded body having a predetermined shape and size. Specifically, the material preparation step may include a step of quenching a molten metal composed of the Al alloy at a cooling rate of 10,000° C./sec or more to produce the thin strip material or powder (hereinafter, referred to as “solidification step”). In addition, the material preparation step may include a step of producing a molded body using the thin strip material or powder (hereinafter, referred to as “molding step”). The molded body is the material to be subjected to the heat treatment. The molded body may be produced by plastic working. Examples of plastic working include forging, rolling, extrusion, drawing, wire drawing, and the like.

<Solidification Step>

In a conventional continuous casting method like that described in Patent Literature 1, the cooling rate of the molten metal at the time of casting is 1000° C./sec or less. The practical cooling rate is about several hundred degrees Celsius per second or less. On the other hand, if the cooling rate is 10,000° C./sec or more (1×10⁴° C./sec or more), the cooling rate is faster than the cooling rate in the conventional continuous casting method. It is considered that the faster cooling rate makes it easier for the Fe atoms to disperse and more difficult for them to gather locally. As a result, it is considered that the Fe—Al compound precipitated at the initial stage tends to be fine. Therefore, if the above-described thin strip material or powder is used and the thermal history is adjusted, the precipitation size of the compound and the crystal size of the matrix tend to be fine in the Al alloy in the final product state. For example, it is easy to obtain an Al alloy having a fine crystal structure with an average crystal grain size of 5 μm or less, and further 1.5 μm or less. That is, compared with general-purpose materials, it is easier to obtain an Al alloy (product) having the above-described specific microstructure.

If the cooling rate of the molten metal is fast, a supersaturated solid solution can be easily obtained. In the supersaturated solid solution, substantially all of the added elements, such as Fe and Nd, are dissolved in the Al, and substantially no precipitates, such as a compound containing Al and Fe, are included. Therefore, the compound does not serve as the starting point of cracking, and the supersaturated solid solution has excellent plastic workability. The supersaturated solid solution has excellent crack resistance even when performing plastic working with a high degree of working. Further, the above-described thin strip material and powder, or flakes and powder obtained by cutting or crushing the thin strip material, are easily subjected to various types of plastic working, and are easy to use. From these points, it can be said that a thin strip material and powder composed of the supersaturated solid solution have a high degree of freedom in their shape after plastic working. If plastic working is appropriately performed using such a thin strip material or powder, molded bodies having various shapes and sizes can be obtained as a material to be subjected to heat treatment. As a result, Al alloys having various shapes and sizes can be obtained.

Further, the strip-shaped material and powder are thin or have a small powder particle size, and so are easy to produce because a cooling rate of 10,000° C./sec or more can be achieved.

The faster the cooling rate of the molten metal, the easier it is to form a supersaturated solid solution and the easier it is for the Fe atoms to disperse. In addition, the crystals that form the matrix tend to become finer. When the cooling rate of the molten metal is 100,000° C./sec or more (1×10⁵° C./sec or more), and further 1,000,000° C./sec or more (1×10⁶° C./sec or more), the formation of the solid solution of Fe and the like and the dispersion of the Fe atoms tend to be promoted, and crystal growth tends to be reduced.

The cooling rate of the molten metal can be adjusted based on, for example, the composition of the molten metal, the temperature of the molten metal, the size of the strip-shaped material or powder to be produced (thickness, powder diameter, and the like), and the like. The cooling rate can be measured by, for example, observing the temperature of the molten metal in contact with the mold by using a high-sensitivity infrared thermography camera. Examples of the infrared thermography camera include an A6750 (time resolution: 0.0002 sec) manufactured by FLIR Systems.

Examples of the mold include copper rolls and the like in the melt spinning method described later. The cooling rate (° C./sec) is calculated at (hot water temperature −300)/t. Here, t (seconds) is the time elapsed during the cooling from the hot water temperature (° C.) to 300° C. For example, if the hot water temperature is 700° C., the cooling rate is calculated at 400/t (° C./sec).

Examples of a method for producing the thin strip material include a so-called liquid quenching solidification method. An example of the liquid quenching solidification method is a melt spinning method. Examples of a method for producing the powder include an atomizing method. An example of the atomizing method is a gas atomizing method.

The melt spinning method is a method for producing a thin strip material in which a supersaturated solid solution is in a continuous strip by injecting and quenching a molten metal of the raw material onto a cooling medium such as a roll or a disk that rotates at high speed. Examples of the cooling medium include cooling media made of a metal such as copper. In the melt spinning method, although the cooling rate depends on the content of Fe and the like, and the thickness and the like of the thin strip material, the cooling rate of the molten metal is 1.5×10⁵° C./sec or more, and can be further set to 5.0×10⁵° C./sec or more, or 1.0×10⁶° C./sec or more. The rotation speed and the like are adjusted so that the cooling rate is 1×10⁴° C./sec or more. By cutting or crushing the thin strip material, at least one selected from the group consisting of length, width, and thickness can be made smaller than the thin strip material. That is, flakes or a powder can be obtained.

The atomizing method is a method of producing a powder by letting the molten metal of the raw material flow out from a small hole at the bottom of a crucible, and injecting a gas with a high cooling capacity or water at high pressure to scatter and quench the thin flow of the molten metal. Examples of the gas include argon gas, air, nitrogen, and the like. The type of cooling medium (gas type and the like), the molten metal state (injection pressure, flow velocity, and the like), temperature, and the like are adjusted so that the cooling rate of the molten metal is 1×10⁴° C./sec or more.

The thickness of the thin strip material and the flakes described above are, for example, 1 μm or more and 100 μm or less, and further 50 μm or less and 40 μm or less. The diameter (powder diameter) of the atomized powder is, for example, 1 μm or more and 20 μm or less, and further 10 μm or less and 5 μm or less.

<Molding Step>

This step includes producing a material (molded body) to be subjected to heat treatment by using one type of plastic working or two or more types of plastic working. That is, the above-described material may be a secondary working material obtained by subjecting a primary working material obtained by plastic working of the thin strip material, flakes, or powder to further plastic working.

It is preferable that the plastic working for producing the above-described material (molded body) is performed under conditions in which it is difficult for the Fe—Al compound to grow in a coarse manner. Examples of such conditions include a working temperature in the above-described plastic working of 500° C. or lower.

In particular, when the working temperature is lower than 400° C., the Fe—Al compound is hardly precipitated or substantially not precipitated during plastic working. In addition, coarse growth due to coalescence of adjacent compounds tends to be reduced. Therefore, during plastic working, cracks due to coarse compounds (precipitates) tend not to occur, and plastic working is easy. The growth of the crystals that form the matrix is also reduced. On the other hand, when the working temperature is 400° C. or higher, the working target (Al alloy) to be subjected to the plastic working is softened during the plastic working, so that the plastic working is easy to carry out.

<<Temperature Conditions During Working>>

A case where the working temperature is lower than 400° C. is typically cold working where the working temperature is lower than 300° C., or warm working where the working temperature is 300° C. or higher and lower than 400° C. As another example, hot working in which the working temperature is 400° C. or higher and 500° C. or lower can be mentioned. The working temperature here is the temperature of the working target such as the thin strip material, flakes, powder, primary working material, and the like described above.

Cold working makes it difficult for the Fe—Al compound to precipitate, and also makes it easy to reduce the growth of compound and the crystals. Further, cold working does not require thermal energy (working temperature: room temperature) or requires only a small amount (working temperature: higher than room temperature and lower than 300° C.). By heating in a range of lower than 300° C., the plastic workability of the work target is enhanced. For example, heating in the range of 200° C. or higher and lower than 300° C. reduces the number of the above-described compound. The reason for this is that compounds having a diameter of 50 nm or less coalesce. By reducing the number of these compounds, effects such as an increase in the conductive path and an improvement in elongation may be obtained. Even in the case of cold working, if the degree of working during plastic working is large, the same effect as when warm working is performed by the heat of working may be obtained.

Warm working can improve the plastic workability and increase the density of the work target. Further, in the case of warm working, it is easy to prevent the Fe—Al compound from excessively precipitating and the compound and the crystals of the matrix from growing excessively. When the working temperature is 320° C. or higher and 390° C. or lower, further 380° C. or lower and 375° C. or lower, and particularly 350° C. or lower, the plastic workability is excellent while excessive growth of the compound is suppressed. Further, as described above, the coalescing of the compounds reduces the number of the compounds, which can be expected to have effects such as an increase in the conductive path and an improvement in elongation.

With hot working at the above-described working temperature of 400° C. or higher and 500° C. or lower, moldability is excellent, and even if a heat treatment is performed after the hot working, the Fe—Al compound and the crystal grains in the matrix tend not to become coarse. When the working temperature is 480° C. or lower, and further 450° C. or lower, the compound and the crystals of the matrix tend to exist as fine particles after the heat treatment.

<<Densification Conditions During Working>>

When producing a material (molded body) to be heat-treated using the thin strip material, flakes, or powder, the plastic working conditions are adjusted according to the working temperature so that the relative density of the finally obtained Al alloy is sufficiently high. The relative density is the apparent density relative to the true density. The relative density of the above-described material and the finally obtained Al alloy is, for example, 95% or more, more preferably 98% or more, and ideally 100%.

<<Rolled Material>>

Examples of the material (molded body) include a rolled material obtained by rolling the thin strip material, and a rolled material obtained by powder-rolling the above-described flakes or powder. A rolled material can be easily obtained, and internal voids are reduced by the plastic working (rolling) to increase the density of the rolled material. Therefore, if the rolled material is used as a material to be subjected to a heat treatment, a long and dense Al alloy can be obtained. Further, the rolled material may be used as a primary working material because it has excellent plastic workability.

<<Compressed Material>>

Another example of the material (molded body) is a compressed material obtained by pressure molding the flakes or powder. The compressed material is dense because internal voids are reduced by pressure compression. Therefore, if this compressed material is used as a material to be subjected to a heat treatment, a dense Al alloy can be obtained. Further, since the compressed material has excellent plastic workability, it may be used as a primary working material. For example, the compressed material can be used as a material for fine wires having a wire diameter of 1 mm or less.

The applied pressure during the pressure compression may be selected within a range in which the relative density of the compressed material is, for example, 90% or more, and further 95% or more and 98% or more. Quantitatively, the applied pressure depends on the working temperature, and examples thereof include 50 MPa or more, 100 MPa or more, and 700 MPa or more. When the applied pressure is 1.8 GPa or less, and further 1.5 GPa or less, it is possible to prevent the compressed material from cracking due to the expansion of air bubbles inside the compressed material. Further, when the applied pressure is in the above-described range, the molding die has excellent durability. The compressed material may be produced, for example, by performing warm working, so-called hot pressing, in which the applied pressure is in the above-described range.

<<Sealed Material>>

Another example of the material (molded body) is a sealed material in which the thin strip material, flakes, or powder, or the above-described compressed material, is sealed in a metal tube and both ends of the metal tube are sealed. The sealed material can prevent the powder or the flakes from scattering even when the powder and the like is used. Further, the sealed material can easily maintain the shape and the like of a stored object even if the stored object is fragile. Since sealed materials tend to have a low relative density, a dense Al alloy can be obtained by using it as a primary worked material. For example, the sealed material can be used as a material for fine wires having a wire diameter of 1 mm or less.

Examples of the metal tube include tubes made of pure aluminum or an aluminum alloy, pure copper, a copper alloy, or the like. Examples of pure aluminum include JIS standard, alloy number A1070, and the like. Examples of aluminum alloys include JIS standard, alloy numbers A5056 and A6063, and the like. The surface layer based on the metal tube may be removed at an appropriate time or kept after molding. When the surface layer is to be kept, a coated Al alloy having the surface layer as a coating layer, for example, a copper-coated Al alloy or the like, is produced. The size of the metal tube may be selected according to the filling amount and size of the stored material, the size of the material, the thickness of the coating layer in the case of a coating layer, and the like.

<<Extruded Material>>

Another example of the material (molded body) is an extruded material obtained by extruding the compressed material or the sealed material. The extruded material is dense because internal voids are reduced by plastic working (extrusion). For example, the relative density of the extruded material is 98% or more, further 99% or more, and substantially 100%. Therefore, if this extruded material is used as a material to be subjected to a heat treatment, a long and dense Al alloy can be obtained. Further, since the extruded material has excellent plastic workability, it may be used as a primary working material. For example, the extruded material can be used as a material for fine wires having a wire diameter of 1 mm or less. An extruded material obtained by extruding a sealed material in which the compressed material is stored is more dense, and can be suitably used as a material for the above-described fine wire. The extrusion pressure depends on the extrusion temperature, and the shape and size of the extruded material, but may be, for example, 1 GPa or more and 2.5 GPa or less. The extruded material may be produced, for example, by performing warm working or hot working in which the extrusion pressure is within the above-described range.

<<Wire Drawing Material>>

Yet another example of the material (molded body) is a wire drawing material obtained by wire drawing the compressed material, the sealed material, or the extruded material. A wire drawing material obtained by subjecting a plastic worked material such as the above-described compressed material to further wire drawing is more dense. If such a wire drawing material is used as a material to be subjected to a heat treatment, a dense Al alloy wire can be obtained.

The wire drawing working is typically cold working, and is performed using a wire drawing die. The wire drawing conditions (working degree per pass, total working degree, and the like) are appropriately selected according to the size of the worked material, such as the above-described compressed material, so that a wire drawing material having a predetermined final wire diameter can be obtained. The wire drawing working may be carried out by referring to known wire drawing conditions.

An intermediate heat treatment can be performed during the wire drawing working until a wire drawing material having the predetermined final wire diameter is obtained. The main purpose of the intermediate heat treatment is to remove the strain associated with the wire drawing working, and it is carried out to increase the wire drawing workability after the intermediate heat treatment. The intermediate heat treatment may be performed at a temperature at which the added elements are unlikely to precipitate (e.g., lower than 400° C.). The holding time in the intermediate heat treatment is 0.5 seconds or more and 3 hours or less.

(Heat Treatment Step)

In this step, a structure in which the Fe—Al compound is dispersed is obtained by subjecting the material (molded body) to a heat treatment to cause the compound including Al and Fe to precipitate and to adjust the size of fine Fe—Al compounds that have already precipitated. For this purpose, the heat treatment conditions are set so that the Fe—Al compound easily precipitates. For example, the heat treatment conditions may be adjusted so that the tensile strength exceeds 200 MPa and the conductivity satisfies 58% IACS or more. Further, the heat treatment conditions are preferably adjusted so that the tensile strength and the conductivity satisfy the above-described ranges and the elongation at break satisfies 7.5% or more. The heat treatment is typically a batch process. If the above-described material is a long material such as wire drawing material, the heat treatment may utilize continuous processing.

<Batch Processing>

<<Heating Temperature>>

In batch processing, the heat treatment target is heated while sealed in a heating container, such as an atmosphere furnace. In the case of batch processing, the heating temperature is, for example, 220° C. or higher and 500° C. or lower. In batch processing, the higher the heating temperature, the easier it is for the Fe—Al compound to precipitate even if the holding time is short. Batch processing has excellent production properties in terms of the point that the holding time is short. In particular, when the heating temperature is 500° C. or lower, it is easy to prevent the above-described compound from growing in a coarse manner as described above, and it is easy to make the compound fine. In addition, thermal alteration of the compound is easily prevented. Further, it is easy to prevent the crystals constituting the matrix from growing in a coarse manner.

On the other hand, even if the heating temperature is low to some extent, if the holding time is lengthened, the Fe—Al compound will precipitate. Moreover, since the heating temperature is low, it is difficult for the compound to grow in a coarse manner. Furthermore, the matrix crystals tend to be finer. For example, when the heating temperature is 400° C. or higher, the compound can be sufficiently precipitated even in a short time to some extent. Further, by performing a heat treatment at 400° C. or higher, the Al alloy has a stable crystal structure. Since the crystals are stable, the strength and conductivity of the Al alloy are unlikely to deteriorate over time even when the environment in which the Al alloy is used is not only room temperature but also a high temperature. Therefore, an Al alloy having excellent conductivity and high strength for a long period of time is produced. The heating temperature may be 420° C. or higher, and further may be 430° C. or higher.

Meanwhile, in terms of suppressing the coarsening of the Fe—Al compound and the crystals of the matrix, the heating temperature may be, for example, 220° C. or higher and lower than 400° C., and further 300° C. or higher. In this temperature range, as described above, the compound coalesces to some extent and the number of the compound is reduced, so that the effects of increasing the conductive path and improving elongation can be expected.

<<Holding Time>>

When the heating temperature is 400° C. or higher and 500° C. or lower, the holding time is, for example, about 1 second or more and 6 hours or less. The higher the heating temperature is, the easier it is for the Fe—Al compound to precipitate even if the holding time is short. The shorter the holding time is, the higher the productivity of the Al alloy. Although the holding time depends on the Fe content, the Nd content, the material size, and the like, the holding time may be, for example, 0.1 hours or more and 4 hours or less, 3 hours or less, 2 hours or less, or 1.5 hours (90 minutes) or less. In the heat treatment step, when the holding time elapses, the heating is stopped and the precipitation operation is ended.

When the heating temperature is 220° C. or higher and lower than 400° C., the holding time is, for example, about 0.1 hours or more and 12 hours or less. It is preferable that the lower the heating temperature is, the longer the holding time is.

When heat treatment is performed with the heating temperature and the holding time within the above-described ranges, typically, an Al alloy having a tensile strength of more than 200 MPa, a conductivity of 58% IACS or more, and an elongation at break of 7.5% or more can be obtained.

Even if the production process of the material to be heat-treated includes hot working, it is easy to appropriately adjust the size of the Fe—Al compound and the size of the matrix crystals by performing the heat treatment independently of the hot working. However, if the thermal history becomes excessive as described above, the compound and the crystals of the matrix grow, and strength and elongation tend to decrease. In addition, the coarse compound impairs the conductive path of the Al, and conductivity tends to decrease.

<Continuous Processing>

In continuous processing, the heat treatment target is continuously fed into a heating container, such as a belt furnace, and heated. In continuous processing, for example, parameters such as the current value, the conveyance speed, and the size of the furnace are adjusted so that the tensile strength and conductivity of the Al alloy after the heat treatment satisfy the above-described ranges.

<Atmosphere>

The atmosphere during the heat treatment may be, for example, an atmospheric atmosphere or a low oxygen atmosphere. An atmospheric atmosphere does not require atmosphere control and is excellent in terms of heat treatment operation properties. A low oxygen atmosphere is an atmosphere in which the oxygen content is lower than that of the atmosphere, and surface oxidation of the Al alloy can be reduced. Examples of the low oxygen atmosphere include a vacuum atmosphere (pressure-reduced atmosphere), an inert gas atmosphere, a reduction gas atmosphere, and the like.

<Other>

In the case of producing the Al alloy wire of the embodiment, the present production method may include, for example, a step of producing a wire drawing material having a predetermined wire diameter as the above-described material to be subjected to a heat treatment. For the production conditions of the wire drawing material, refer to the above section <<Wire drawing material>>.

In the case of producing a stranded wire that includes the Al alloy wire of the embodiment as a wire, the heat treatment material that has undergone the heat treatment step may be twisted, or the above-described wire drawing material may be twisted and then the heat treatment step may be performed. When producing a compressed stranded wire, the above-described heat-treated material may be twisted and then compressed, or the above-described wire drawing material may be twisted and then subjected to the heat treatment and then compressed, or the above-described wire drawing material may be twisted, then compressed, and then subjected to the heat treatment.

The material before the heat treatment, the heat-treated material after the heat treatment, and the like may be cut or the like as necessary. Further, it is conceivable to use solid-phase sintering as the molding method for producing the material before the heat treatment. However, adjustments such as lowering the sintering temperature and the like would need to be made.

### Test Example 1

Al alloy including Fe and Nd were produced under the following conditions, and the structure, mechanical properties, and electrical properties thereof were examined. The production conditions and composition are shown in the odd-numbered tables among the following Tables 1 to 14. The following even-numbered tables among Tables 1 to 14 show the structure, the mechanical properties and the electrical properties.

(Preparation of Samples)

Each of the samples was produced as follows. First, a thin strip material was prepared by a melt spinning method. Using this thin strip material, the material to be subjected to the heat treatment was produced. The material was an extruded material produced by subjecting the thin strip material to, in order, hot-pressing and extrusion.

As raw materials, pure aluminum, pure iron, pure neodymium, or the following alloys were prepared. These alloys were alloys (a binary alloy or a ternary alloy) including two or more of the three elements Fe, Al, and Nd.

The pure aluminum was aluminum bullion with a purity of 2N (Al content of 99.7% by mass) or aluminum bullion with a purity of 3N (Al content of 99.9% by mass).

The Al alloys other than the samples shown in Tables 5 and 6 were prepared using aluminum bullion with a purity of 3N. Further, the pure iron and pure neodymium were both pure metal having a purity of 3N.

For the Al alloys of Sample No. 11 and Sample No. 12 shown in shown in Tables 5 and 6, aluminum bullion with a purity of 3N and a purity of 2N, respectively, were used.

The alloys used as the above-described raw materials can be produced by a known production method or the like by using, for example, a graphite electric furnace, a high-frequency melting furnace, an arc melting furnace, or the like. Examples of the production of these alloys include the use of the above-described aluminum bullion and pure metal, and the use of an alloy having a composition that is economically more easily available (an alloy having a composition having a low melting point, and the like).

A molten metal is prepared using the raw materials. The amount of pure iron and the amount of pure neodymium added to the aluminum bullion, or the amount of the alloys added used as the raw materials are adjusted so that the Fe content and the Nd content in the molten metal are the amounts (% by mass) shown in the odd-numbered tables. The molten metal to be produced contains the amounts (% by mass) of Fe and Nd shown in the odd-numbered tables, and the balance is Al and impurities. The Fe content (% by mass) and Nd content (% by mass) are the mass ratio of Fe and the mass ratio of Nd when the Al alloy is 100% by mass. The impurities here are mainly O (oxygen), Si (silicon), and C (carbon).

Sample No. 1 to No. 4, No. 101, and No. 102 shown in Table 1 all have the same Nd content, but have a different Fe content. The Fe content is a value selected from 0.05% by mass to 3.25% by mass. The Nd content is 0.080% by mass.

Sample No. 5 to No. 10, No. 103, and No. 104 shown in Table 3 all have the same Fe content, but have a different Nd content. The Nd content is a value selected from 0.001% by mass to 2.50% by mass. The Fe content is 2.0% by mass.

Sample No. 11 and No. 12 shown in Table 5 both have the same Fe content and Nd content, but the total content of impurities is different. The Fe content is 2.0% by mass. The Nd content is 0.080% by mass.

Sample No. 13 to No. 36 shown in Table 7 onwards all have the same composition. The Fe content is 2.0% by mass. The Nd content is 0.080% by mass.

Sample No. 1 to No. 10 and No. 13 to No. 36 have a total content of impurities of 0.05% by mass.

Here, the total content of impurities depends on the purity of the raw material aluminum bullion and the purity of the pure iron.

Using the produced molten metal, a thin strip material was produced by a melt spinning method. Specifically, the temperature was raised to 900° C. in a reduced pressure argon atmosphere (−0.02 MPa) to dissolve the raw materials and produce a molten metal. The molten metal was sprayed onto a copper roll rotating at a peripheral speed of 50 m/sec to produce a thin strip material. The width of the thin strip material was about 2 mm. The thickness of the thin strip material was about 30 μm. The length of the thin strip material was indefinite. The theoretical cooling rate (calculated value) of the molten metal under these conditions was 7.5×10⁶° C./sec (≥10,000° C./sec).

The thin strip material was appropriately crushed into a powder. Using this powder, a compressed material was produced by hot pressing (warm plastic working). The conditions of the hot pressing were an argon atmosphere, an applied pressure of 1.5 GPa, a working temperature of 320° C., and a holding time of 5 seconds. The compressed material had a columnar shape, a diameter of 40 mmφ, a length of 10 mm, and a relative density of 95%. The relative density was obtained from (apparent density/true density)×100, using the apparent density and the true density of the compressed material. The apparent density is the mass per unit volume obtained by (mass/volume)×100 using the mass and volume measured including the pores included inside the compressed material. The true density of the compressed material can be calculated, for example, based on the composition of the Al alloy by performing a composition analysis on the compressed material.

The compressed material of each obtained sample was inserted into an aluminum tube, and then both ends of the aluminum tube were sealed to produce a sealed material. The sealed material was extruded to produce an extruded material. The aluminum tube was composed of a 1000 series aluminum alloy (JIS standard, alloy number A1070), had an outer diameter of 40 mmφ and a thickness of 1 mm. Here, the compressed material was worked so as to have an outer diameter in accordance with the inner diameter of the aluminum pipe, and then inserted into the aluminum pipe. A1070 has better plastic workability than the thin strip material made of Al alloy, and is easy to use. The aluminum tube was sealed in an argon atmosphere. The compressed material may be extruded without using the aluminum tube.

The extrusion was performed using a hydraulic extruder. The odd-numbered tables show the extrusion temperature (° C.) and the extrusion pressure (GPa). The extruded material was a round bar having a diameter of 10 mmφ and a relative density of about 100%. The method for measuring the relative density was the same as that for the compressed material described above. Here, after extrusion, the surface layer based on the aluminum pipe was cut away. It is also possible to leave the surface layer based on the aluminum tube and use an extruded material having the surface layer.

A heat treatment (annealing) was performed on the extruded material of each obtained sample. The heat treatment here was a batch process. The odd-numbered tables show the heating temperature (° C.). The heat treatment atmosphere was a nitrogen atmosphere, and the heat treatment holding time was 30 minutes.

In the samples shown in Tables 1 to 6, the extrusion temperature was 350° C., the extrusion pressure was 1.5 GPa, and the heating temperature of the heat treatment was 400° C.

In the samples shown in Tables 7 and 8, the extrusion temperature was a temperature (° C.) selected from 320° C. to 450° C., the extrusion pressure was a pressure (GPa) selected from 1.0 GPa to 2 GPa, and the heating temperature of the heat treatment was a temperature (° C.) selected from 225° C. to 400° C.

In the samples shown in Tables 9 and 10, the extrusion temperature was 420° C., the extrusion pressure was 1.2 GPa, and the heating temperature of the heat treatment was a temperature (° C.) selected from 250° C. to 430° C.

In the samples shown in Tables 11 and 12, the extrusion temperature was 350° C., the extrusion pressure was 2 GPa, and the heating temperature of the heat treatment was a temperature (° C.) selected from 380° C. to 500° C.

In the samples shown in Tables 13 and 14, the extrusion temperature was 300° C., the extrusion pressure was 2 GPa, and the heating temperature of the heat treatment was a temperature (° C.) selected from 225° C. to 480° C. It is noted that the units of the “compound average density” in Table 14 were “number/5 μm-square”.

(Mechanical Properties and Electrical Properties)

The tensile strength (MPa), elongation at break (%), and conductivity (% IACS) of test pieces cut from the heat-treated material of each of the obtained samples were measured at room temperature (25° C. in this case). The tensile strength (MPa) was measured at 150° C. The measurement results are shown in the even-numbered tables.

The tensile strength (MPa) and elongation at break (%) were measured in accordance with ITS Z 2241 (Metallic material tensile test method, 1998). For the measurement, a commercially available measuring apparatus capable of a tensile test at room temperature and at 150° C. can be used.

The conductivity (% IACS) was measured by a bridge method.

(Structure Observation)

An arbitrary cross section of the heat-treated material of each obtained sample was taken, and the cross section was observed with a microscope at an appropriate magnification (e.g., 10,000 times). Here, a scanning electron microscope (SEM) was used for observing the cross section, but a metallurgical microscope may be used.

In the cross section, the heat-treated material of each sample had a structure in which the matrix had a crystal structure and particles composed of a compound including Al and Fe (e.g., Al₁₃Fe₄) were dispersed in the matrix. The compound was mainly a precipitate.

In the cross section, the average crystal grain size (μm) of the crystals constituting the matrix, the average major axis length (nm) of the compound including Al and Fe, the average aspect ratio of the compound, and the average density of the compound (number/(5 μm×5 μm)) were measured. The measurement results are shown in the even-numbered tables.

<Matrix Crystal Grains>

The average crystal grain size (nm) of the crystal was calculated as follows.

In the heat-treated material of each sample, 30 or more square measurement areas (fields of view) with sides of 10 μm were taken from an SEM image of the above-described cross section. Alternatively, a total of 30 or more measurement areas may be obtained by capturing a plurality of arbitrary cross sections, and taking one measurement area or a plurality of measurement areas from each cross section.

All the crystal grains present in each of the measurement areas were extracted. A circle having an area equivalent to the cross-sectional area of each crystal grain, that is, an equivalent area circle, was obtained. The diameter of each circle, that is, the equivalent diameter of the circle, was defined as the particle size of each crystal grain. The particle size of the extracted crystal grains was averaged, and the obtained average value was taken as the average crystal grain size.

The magnification of observation here was 10,000 times. With resolution at this magnification, it is very difficult to clearly measure crystals and compounds having a size of less than 0.01 μm. Therefore, here, a crystal having a particle size of 0.05 μm or more was used for calculating the average crystal particle size. Crystal grains having a particle size of less than 0.05 μm were not used in the calculation of the average crystal grain size.

<Compound>

In the heat-treated material of each sample, 10 or more square measurement areas (fields of view) with sides of 5 μm were taken from an SEM image of the above-described cross section. Alternatively, a total of 10 or more measurement areas may be obtained by capturing a plurality of arbitrary cross sections, and taking one measurement area or a plurality of measurement areas from each cross section.

The average major axis length (nm) of the compound including Al and Fe was calculated as follows.

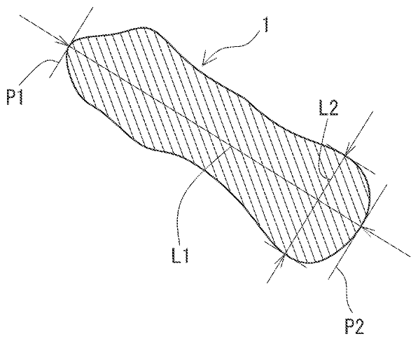

All of the Fe—Al compounds present in each of the measurement areas were extracted. The maximum length of each extracted Fe—Al compound was measured. The maximum length of each Fe—Al compound was measured as follows. As shown in FIG. 1, in the SEM image of the cross section, a particle 1 composed of the Fe—Al compound was sandwiched by two parallel lines P1 and P2, and the interval between the parallel lines P1 and P2 was measured. The interval is the distance in the direction orthogonal to the parallel lines P1 and P2. A plurality of pairs of parallel lines P1 and P2 were taken in an arbitrary direction, and the interval of each of those sets of parallel lines was measured. Of the plurality of measured intervals, the maximum value is defined as a maximum length L1 of the particle 1. The magnification of observation was 10,000 times. Here, the Fe—Al compounds having a maximum length of 0.01 μm or more were extracted. Fe—Al compounds with a maximum length of less than 0.01 μm were not used in the calculation of the average major axis length. The maximum length of each extracted Fe—Al compound was averaged, and the calculated average value was taken as the average major axis length.

The average aspect ratio of the compound including Al and Fe was calculated as follows.

The aspect ratio of the Fe—Al compound was taken as the ratio of the major axis length to the minor axis length of the Fe—Al compound, that is, (major axis length/minor axis length). For each Fe—Al compound extracted from each measurement area as described above, a maximum length L1 (=major axis length) was measured as described above. Line segments in a direction orthogonal to the direction along the maximum length L1 of each Fe—Al compound were taken, and the maximum value among the lengths of these line segments was used as a minor axis length L2. For each Fe—Al compound, the aspect ratio was determined using the major axis length L1 and the minor axis length L2. Here, the aspect ratio was determined for the Fe—Al compounds having a major axis length of 0.01 μm or more as described above. The aspect ratio of each obtained Fe—Al compound was averaged. The calculated average value was taken as the average aspect ratio.

The average density of the compound including Al and Fe (number/(5 μm×5 μm)) was calculated as follows.

The number of the Fe—Al compound present in each of the above-described measurement areas and having a maximum length of 0.01 pun or more was measured. The number of the Fe—Al compound in 10 or more measurement areas was totaled, and this total number was averaged by dividing it by the number of measurement areas (10 or more). The obtained average value was taken as the average density, that is, the average number of the Fe—Al compound in the measurement area of 5 μm×5 μm. The observation magnification here was 30,000 times.

The extraction of and the measurement of the size of the crystal grains and the compound including Al and Fe can be easily performed by image processing the SEM image using commercially available image processing software. The magnification of the microscope is, as described above, adjusted within a clearly measurable range of the size of the object to be measured. When observing the cross sections, it is effective to perform grain boundary etching by an appropriate solution treatment and to obtain an SEM image having crystal orientation information by an electron backscatter diffraction method (EBSD).

(Component Analysis)

In addition, the structure of the compound including Al and Fe (e.g., Al₁₃Fe₄) can be investigated by performing structural analysis by, for example, X-ray diffraction (XRD) on the cross section of the heat-treated material of each sample. The structural analysis can be performed accurately by performing it after sufficiently removing surface oxides and the like, or by evaluating the inside of the sample by transmissive XRD or the like using radiated light.

The position of the Nd in the heat-treated material of each sample can be confirmed, for example, by identifying the elements constituting the compound that includes Al and Fe and the elements constituting the matrix. For the identification, an apparatus capable of local component analysis can be used. Examples of such an apparatus include a SEM and a transmission electron microscope (TEM) attached to a measuring apparatus that uses energy dispersive X-ray spectroscopy (EDX). Further, the Al content and the Fe content (solid solution amount) in the matrix can be measured by an electron probe microanalyzer (EPMA).

TABLE 1

| | | | Impurities | |
|---|---|---|---|---|
| Sample | Fe content | Nd content, | content (% | |
| No. | (% by mass) | (% by mass) | by mass) | Production conditions |
| 101 | 0.05 | 0.080 | 0.05 | Press molding (1.5 GPa) at 320° C. + extrusion (1.5 GPa) at 350° C. + annealing at 400° C. |
| 1 | 0.10 | 0.080 | 0.05 | Press molding (1.5 GPa) at 320° C. + extrusion (1.5 GPa) at 350° C. + annealing at 400° C. |
| 2 | 0.75 | 0.080 | 0.05 | Press molding (1.5 GPa) at 320° C. + extrusion (1.5 GPa) at 350° C. + annealing at 400° C. |
| 3 | 1.00 | 0.080 | 0.05 | Press molding (1.5 GPa) at 320° C. + extrusion (1.5 GPa) at 350° C. + annealing at 400° C. |
| 4 | 2.80 | 0.080 | 0.05 | Press molding (1.5 GPa) at 320° C. + extrusion (1.5 GPa) at 350° C. + annealing at 400° C. |
| 102 | 3.25 | 0.080 | 0.05 | Press molding (1.5 GPa) at 320° C. + extrusion (1.5 GPa) at 350° C. + annealing at 400° C. |

TABLE 2

| | Composition | | | | | | | |
|---|---|---|---|---|---|---|---|---|
| | | | | Compound | Room temperature | | 150° C. | Room |
| | Average crystal grain | | | average density | Tensile | Elongation | Tensile | temperature |
| Sample | size (μm; circle | Compound size | Compound | (number / square 5 | strength | at break | strength | Conductivity |
| No. | equivalent) | (nm; major axis) | aspect ratio | μm) | (MPa) | (%) | (MPa) | (% IACS) |
| 101 | 1.95 | 30 | 1.6 | 70 | 140 | 23.0 | 70 | 63 |
| 1 | 1.21 | 35 | 1.8 | 110 | 210 | 18.0 | 150 | 62 |
| 2 | 1.05 | 40 | 1.8 | 660 | 230 | 16.0 | 160 | 62 |
| 3 | 0.63 | 41 | 1.9 | 860 | 295 | 15.0 | 215 | 61 |
| 4 | 0.60 | 43 | 2.0 | 1,730 | 320 | 15.0 | 220 | 60 |
| 102 | 0.55 | 64 | 2.3 | 2,040 | 345 | 15.0 | 245 | 53 |

TABLE 3

| | | | Impurities | |
|---|---|---|---|---|
| Sample | Fe content | Nd content, | content (% | |
| No. | (% by mass) | (% by mass) | by mass) | Production conditions |
| 103 | 2.0 | 0.001 | 0.05 | Press molding (1.5 GPa) at 320° C. + extrusion (1.5 GPa) at 350° C. + annealing at 400° C. |
| 5 | 2.0 | 0.002 | 0.05 | Press molding (1.5 GPa) at 320° C. + extrusion (1.5 GPa) at 350° C. + annealing at 400° C. |
| 6 | 2.0 | 0.01 | 0.05 | Press molding (1.5 GPa) at 320° C. + extrusion (1.5 GPa) at 350° C. + annealing at 400° C. |
| 7 | 2.0 | 0.08 | 0.05 | Press molding (1.5 GPa) at 320° C. + extrusion (1.5 GPa) at 350° C. + annealing at 400° C. |
| 8 | 2.0 | 0.50 | 0.05 | Press molding (1.5 GPa) at 320° C. + extrusion (1.5 GPa) at 350° C. + annealing at 400° C. |
| 9 | 2.0 | 1.00 | 0.05 | Press molding (1.5 GPa) at 320° C. + extrusion (1.5 GPa) at 350° C. + annealing at 400° C. |
| 10 | 2.0 | 2.00 | 0.05 | Press molding (1.5 GPa) at 320° C. + extrusion (1.5 GPa) at 350° C. + annealing at 400° C. |
| 104 | 2.0 | 2.50 | 0.05 | Press molding (1.5 GPa) at 320° C. + extrusion (1.5 GPa) at 350° C. + annealing at 400° C. |

TABLE 4

| | Composition | | | | | | | |
|---|---|---|---|---|---|---|---|---|
| | | | | Compound | Room temperature | | 150° C. | Room |
| | Average crystal grain | | | average density | Tensile | Elongation | Tensile | temperature |
| Sample | size (μm; circle | Compound size | Compound | (number / square 5 | strength | at break | strength | Conductivity |
| No. | equivalent) | (nm; major axis) | aspect ratio | μm) | (MPa) | (%) | (MPa) | (% IACS) |
| 103 | 5.22 | 70 | 2.1 | 210 | 160 | 17.0 | 110 | 61 |
| 5 | 3.47 | 68 | 2.1 | 380 | 230 | 17.0 | 155 | 61 |
| 6 | 1.40 | 46 | 2.0 | 960 | 275 | 19.0 | 190 | 61 |
| 7 | 0.61 | 42 | 2.0 | 1,260 | 305 | 20.0 | 220 | 61 |
| 8 | 0.73 | 40 | 2.0 | 1,400 | 310 | 21.0 | 225 | 60 |
| 9 | 0.85 | 74 | 2.3 | 370 | 355 | 12.0 | 260 | 59 |
| 10 | 1.33 | 110 | 2.5 | 130 | 385 | 7.5 | 275 | 58 |
| 104 | 1.56 | 245 | 2.8 | 92 | 405 | 3.0 | 290 | 51 |

TABLE 5

| | | | Impurities | |
|---|---|---|---|---|
| Sample | Fe content | Nd content | content (% | |
| No. | (% by mass) | (% by mass) | by mass) | Production conditions |
| 11 | 2.0 | 0.08 | 0.1 | Press molding (1.5 GPa) at 320° C. + extrusion (1.5 GPa) at 350° C. + annealing at 400° C. |
| 12 | 2.0 | 0.08 | 0.3 | Press molding (1.5 GPa) at 320° C. + extrusion (1.5 GPa) at 350° C. + annealing at 400° C. |

TABLE 6

| | Composition | | | | | | | |
|---|---|---|---|---|---|---|---|---|
| | | | | Compound | Room temperature | | 150° C. | Room |
| | Average crystal grain | | | average density | Tensile | Elongation | Tensile | temperature |
| Sample | size (μm; circle | Compound size | Compound | (number / square 5 | strength | at break | strength | Conductivity |
| No. | equivalent) | (nm; major axis) | aspect ratio | μm) | (MPa) | (%) | (MPa) | (% IACS) |
| 11 | 0.58 | 41 | 1.8 | 1,300 | 320 | 18.0 | 230 | 61 |
| 12 | 0.53 | 68 | 2.2 | 480 | 265 | 8.0 | 200 | 58 |

TABLE 7

| | | | Impurities | |
|---|---|---|---|---|
| Sample | Fe content | Nd content | content (% | |
| No. | (% by mass) | (% by mass) | by mass) | Production conditions |
| 13 | 2.0 | 0.08 | 0.05 | Press molding (1.5 GPa) at 320° C. + extrusion (2 GPa) at 320° C. + annealing at 225° C. |
| 14 | 2.0 | 0.08 | 0.05 | Press molding (1.5 GPa) at 320° C. + extrusion (2 GPa) at 320° C. + annealing at 250° C. |
| 15 | 2.0 | 0.08 | 0.05 | Press molding (1.5 GPa) at 320° C. + extrusion (2 GPa) at 320° C. + annealing at 280° C. |
| 16 | 2.0 | 0.08 | 0.05 | Press molding (1.5 GPa) at 320° C. + extrusion (2 GPa) at 320° C. + annealing at 320° C. |
| 17 | 2.0 | 0.08 | 0.05 | Press making (1.5 GPa) at 320° C. + extrusion (1.2 GPa) at 380° C. + annealing at 400° C. |
| 18 | 2.0 | 0.08 | 0.05 | Press molchng (1.5 GPa) at 320° C. + extrusion (1.0 GPa) at 420° C. + annealing at 400° C. |
| 19 | 2.0 | 0.08 | 0.05 | Press molding (1.5 GPa) at 320° C. + extrusion (1.0 GPa) at 450° C. + annealing at 400° C. |

TABLE 8

| | Composition | | | | | | | |
|---|---|---|---|---|---|---|---|---|
| | | | | Compound | Room temperature | | 150° C. | Room |
| | Average crystal grain | | | average density | Tensile | Elongation | Tensile | temperature |
| Sample | size (μm; circle | Compound size | Compound | (number / square 5 | strength | at break | strength | Conductivity |
| No. | equivalent) | (nm; major axis) | aspect ratio | μm) | (MPa) | (%) | (MPa) | (% IACS) |
| 13 | 0.09 | 23 | 1.7 | 5,500 | 430 | 7.5 | 295 | 58 |
| 14 | 0.11 | 27 | 1.8 | 4,750 | 365 | 9.0 | 250 | 60 |
| 15 | 0.23 | 30 | 1.9 | 2,940 | 310 | 12.0 | 215 | 60 |
| 16 | 0.30 | 32 | 2.0 | 2,510 | 275 | 15.0 | 190 | 60 |
| 17 | 1.40 | 78 | 2.2 | 1,100 | 255 | 18.0 | 175 | 61 |
| 18 | 5.00 | 100 | 2.2 | 600 | 235 | 15.0 | 165 | 61 |
| 19 | 5.50 | 126 | 2.4 | 120 | 205 | 10.0 | 155 | 61 |

TABLE 9

| | | | Impurities | |
|---|---|---|---|---|
| Sample | Fe content | Nd content | content (% | |
| No. | (% by mass) | (% by mass) | by mass) | Production conditions |
| 20 | 2.0 | 0.08 | 0.05 | Press molding (1.5 GPa) at 320° C. + extrusion (1.2 GPa) at 420° C. + annealing at 250° C. |
| 21 | 2.0 | 0.08 | 0.05 | Press molding (1.5 GPa) at 320° C. + extrusion (1.2 GPa) at 420° C. + annealing at 280° C. |
| 22 | 2.0 | 0.08 | 0.05 | Press molding (1.5 GPa) at 320° C. + extrusion (1.2 GPa) at 420° C. + annealing at 320° C. |
| 23 | 2.0 | 0.08 | 0.05 | Press molding (1.5 GPa) at 320° C. + extrusion (1.2 GPa) at 420° C. + annealing at 350° C. |
| 24 | 2.0 | 0.08 | 0.05 | Press molding (1.5 GPa) at 320° C. + extrusion (1.2 GPa) at 420° C. + annealing at 430° C. |

TABLE 10

| | Composition | | | | | | | |
|---|---|---|---|---|---|---|---|---|
| | | | | Compound | Room temperature | | 150° C. | Room |
| | Average crystal grain | | | average density | Tensile | Elongation | Tensile | temperature |
| Sample | size (μm; circle | Compound size | Compound | (number / square 5 | strength | at break | strength | Conductivity |
| No. | equivalent) | (nm; major axis) | aspect ratio | μm) | (MPa) | (%) | (MPa) | (% IACS) |
| 20 | 1.42 | 120 | 1.7 | 400 | 310 | 17.0 | 215 | 62 |
| 21 | 2.33 | 500 | 3.2 | 150 | 255 | 16.0 | 180 | 61 |
| 22 | 3.71 | 680 | 4.8 | 120 | 230 | 15.0 | 170 | 60 |
| 23 | 4.83 | 750 | 6.2 | 110 | 210 | 14.0 | 165 | 59 |
| 24 | 7.56 | 800 | 7.1 | 80 | 205 | 15.0 | 155 | 58 |

TABLE 11

| | | | Impurities | |
|---|---|---|---|---|
| Sample | Fe content | Nd content | content (% | |
| No. | (% by mass) | (% by mass) | by mass) | Production conditions |
| 25 | 2.0 | 0.08 | 0.05 | Press molding (1.5 GPa) at 320° C. + extrusion (2 GPa) at 350° C. + annealing at 380° C. |
| 26 | 2.0 | 0.08 | 0.05 | Press molding (1.5 GPa) at 320° C. + extrusion (2 GPa) at 350° C. + annealing at 420° C. |
| 27 | 2.0 | 0.08 | 0.05 | Press molding (1.5 GPa) at 320° C. + extrusion (2 GPa) at 350° C. + annealing at 440° C. |
| 28 | 2.0 | 0.08 | 0.05 | Press molding (1.5 GPa) at 320° C. + extrusion (2 GPa) at 350° C. + annealing at 480° C. |
| 29 | 2.0 | 0.08 | 0.05 | Press molcting (1.5 GPa) at 320° C. + extrusion (2 GPa) at 350° C. + annealing at 500° C. |

TABLE 12

| | Composition | | | | | | | |
|---|---|---|---|---|---|---|---|---|
| | | | | Compound | Room temperature | | 150° C. | Room |
| | Average crystal grain | | | average density | Tensile | Elongation | Tensile | temperature |
| Sample | size (μm; circle | Compound size | Compound | (number / square 5 | strength | at break | strength | Conductivity |
| No. | equivalent) | (nm; major axis) | aspect ratio | μm) | (MPa) | (%) | (MPa) | (% IACS) |
| 25 | 1.21 | 84 | 2.1 | 1,580 | 345 | 16.0 | 260 | 62 |
| 26 | 1.93 | 110 | 2.5 | 1,200 | 330 | 15.0 | 245 | 61 |
| 27 | 2.46 | 146 | 2.8 | 892 | 260 | 12.0 | 160 | 60 |
| 28 | 3.15 | 214 | 3.5 | 470 | 240 | 10.0 | 155 | 58 |
| 29 | 4.22 | 231 | 4.1 | 421 | 210 | 8.0 | 150 | 58 |

TABLE 13

| | | | Impurities | |
|---|---|---|---|---|
| Sample | Fe content | Nd content | content (% | |
| No. | (% by mass) | (% by mass) | by mass) | Production conditions |
| 30 | 2.0 | 0.08 | 0.05 | Press molding (1.5 GPa) at 320° C. + extrusion (2 GPa) at 300° C. + annealing at 225° C. |
| 31 | 2.0 | 0.08 | 0.05 | Press molding (1.5 GPa) at 320° C. + extrusion (2 GPa) at 300° C. + annealing at 250° C. |
| 32 | 2.0 | 0.08 | 0.05 | Press molding (1.5 GPa) at 320° C. + extrusion (2 GPa) at 300° C. + annealing at 280° C. |
| 33 | 2.0 | 0.08 | 0.05 | Press molding (1.5 GPa) at 320° C. + extrusion (2 GPa) at 300° C. + annealing at 320° C. |
| 34 | 2.0 | 0.08 | 0.05 | Press molding (1.5 GPa) at 320° C. + extrusion (2 GPa) at 300° C. + annealing at 400° C. |
| 35 | 2.0 | 0.08 | 0.05 | Press molding (1.5 GPa) at 320° C. + extrusion (2 GPa) at 300° C. + annealing at 450° C. |
| 36 | 2.0 | 0.08 | 0.05 | Press molding (1.5 GPa) at 320° C. + extrusion (2 GPa) at 300° C. + annealing at 480° C. |

TABLE 14

| | Composition | | | | | | | |
|---|---|---|---|---|---|---|---|---|
| | | | | Compound | Room temperature | | 150° C. | Room |
| | Average crystal grain | | | average density | Tensile | Elongation | Tensile | temperature |
| Sample | size (μm; circle | Compound size | Compound | (number / square 5 | strength | at break | strength | Conductivity |
| No. | equivalent) | (nm; major axis) | aspect ratio | μm) | (MPa) | (%) | (MPa) | (% IACS) |
| 30 | 0.08 | 40 | 1.7 | 6,200 | 440 | 7.5 | 310 | 58 |
| 31 | 0.12 | 47 | 1.8 | 5,000 | 370 | 9.0 | 260 | 60 |
| 32 | 0.22 | 52 | 1.9 | 3,000 | 315 | 16.0 | 220 | 60 |
| 33 | 0.36 | 72 | 2.0 | 2,190 | 260 | 18.0 | 190 | 62 |
| 34 | 4.71 | 173 | 2.2 | 400 | 255 | 15.0 | 180 | 61 |
| 35 | 5.23 | 310 | 2.2 | 171 | 220 | 15.0 | 160 | 59 |
| 36 | 5.71 | 415 | 2.4 | 80 | 200 | 10.0 | 155 | 59 |

(Overview)

As shown in the even-numbered tables, it can be seen that the Al alloys of Sample No. 1 to No. 36 having a composition including Fe in the specific range and including Nd in the specific range had better strength while having the same or higher conductivity than the Al alloy wire described in Patent Literature 1. Quantitatively, the Al alloys of Sample No. 1 to No. 36 (hereinafter, referred to as “Al alloys of the specific samples”) had a conductivity of 58% IACS or more at room temperature and a tensile strength of more than 200 MPa at room temperature.

It can also be seen that all of the Al alloys of the specific samples had high elongation and excellent toughness. Quantitatively, the elongation at break at room temperature was 7.5% or more.

Furthermore, all of the Al alloys of the specific samples also had excellent heat resistance. Quantitatively, the tensile strength at 150° C. was 150 MPa or more.

One of the reasons why the Al alloys of the specific samples had high conductivity and superior strength is considered to be because the Al alloys had the following specific structure. The specific structure is a structure in which the matrix is composed of fine crystals, and a fine Fe—Al compound, typically an intermetallic compound including Al and Fe, is dispersed in the matrix. One of the reasons why this specific structure can be obtained is considered to be as follows. The above-described compound tends to coarsen. However, when an appropriate amount of Nd is included, the compound is less likely to become coarse after the heat treatment, and exists as a fine precipitate. If the compound is fine, the crystals constituting the matrix are less likely to coarsen and tend to be fine during a heat treatment or the like. Here, since the cooling rate of the molten metal is very high, the compound that precipitates at the initial stage tends to be fine, and the crystals constituting the matrix of the thin strip material tend to be fine. From this point as well, it is considered that the compound and the crystals constituting the matrix tend to be fine after the heat treatment.

An arbitrary cross section was taken in the Al alloys of the specific samples, and the existence state of the Nd was investigated. Here, the cross section of the Al alloy of each specific sample was enlarged 10,000 times, and point analysis and plane analysis were performed by a SEM-EDX and an EPMA. As a result, in the Al alloy of each specific sample, it was confirmed that the Nd was mainly present in the Fe—Al compound (as a solid solution) or at the grain boundary between the crystals constituting the matrix and the compound. Since the Nd was present in or in the vicinity of the compound, it is considered that it contributes to the miniaturization of the compound.

The improvement in the strength of the Al alloys of the specific samples having the above-described specific structure can be considered as being due to the effect of an improvement in strength by strengthening of the grain boundaries of fine crystals and the effect of an improvement in strength by dispersion strengthening of the fine Fe—Al compound. Further, it can be considered that the Al alloys of the specific samples having the above-described specific structure have excellent conductivity due to a reduced solid solution amount of Fe in Al, and the fact that the fine Fe—Al compound is less likely to impair the conductive path of the Al. In addition, the Al alloys of the specific samples having the above-described specific structure are considered to have excellent elongation because a fine Fe—Al compound is unlikely to serve as a starting point of cracking. Moreover, the Al alloys of the specific samples having the above-described specific structure are considered to have excellent heat resistance because the specific structure tends to be maintained even at a high temperature.

The description will now focus on the Fe content and the Nd content, respectively. Further, for Al alloys having the same Fe content and Nd content, that is, having the same composition, the amount of impurities, the crystal grain size in the matrix, the size, shape, and abundance of the compound including Al and Fe will each be focused on.

(Fe Content)

As shown in Tables 1 and 2, it can be seen that the higher the Fe content, the higher the tensile strength at both room temperature and a high temperature (150° C.), the higher the strength of the Al alloy, and the better the heat resistance. However, if the amount of Fe is too large, the conductivity decreases (Sample No. 102). The smaller the Fe content, the higher the conductivity tends to be, and the Al alloy has excellent conductivity. Further, the smaller the Fe content, the higher the elongation tends to be, and the Al alloy also has excellent elongation. However, if the amount of Fe is too small, strength and heat resistance decrease (Sample No. 101).

Here, the Al alloys of Sample No. 1 to No. 4, in which the Fe content was more than 0.05% by mass and less than 3.00% by mass, had a tensile strength of more than 200 MPa, and further 210 MPa or more, and a conductivity of 58% IACS or more, and further 60% IACS or more. In addition, in these Al alloys, the average crystal grain size of the matrix was small (1.5 μm or less here), and the average major axis length of the Fe—Al compound was short (100 nm or less here). It can be said that such an Al alloy has the above-described specific structure, and it is considered that strength can be improved while having excellent conductivity.

Furthermore, the Al alloys of Sample No. 1 to No. 4 had a small average aspect ratio of the Fe—Al compound (2.5 or less here), and an appropriate amount of the compound was present (here, the average density was 100 or more and 3000 or less, and further 2000 or less). Such an above-described compound tends to be uniformly dispersed in the matrix, and thus it is considered that the strength of the Al alloy is likely to be improved. This is supported by the fact that the Al alloy of Sample No. 101, in which the Fe content was too low, the average density of the compound was as small as less than 100, and the tensile strength was as low as 140 MPa. Moreover, it is considered that such an above-described compound tends not to serve as a starting point of cracking. Therefore, the Al alloys of Sample No. 1 to No. 4 also have excellent elongation, and the elongation at break was 15% or more.

From Tables 1 and 2, it can be said that the Fe content is preferably 0.1% by mass or more and 2.8% by mass or less. When the Fe content is more than 0.75% by mass and 2.6% by mass or less, and further 1.0% by mass or more and 2.4% by mass or less, the tensile strength at room temperature is 250 MPa or more, and hence can be said to have even better strength. Further, in this case, the tensile strength at high temperature is 180 MPa or more, and further 200 MPa or more, and it can be said that the heat resistance is also excellent.

(Nd Content)

As shown in Tables 3 and 4, it can be seen that the higher the Nd content, the higher the tensile strength at both room temperature and a high temperature (150° C.), the higher the strength of the Al alloy, and the better the heat resistance. However, if the amount of Nd is too large, the conductivity decreases (Sample No. 104). The smaller the Nd content, the higher the conductivity tends to be, and the Al alloy has excellent conductivity. Further, the smaller the Nd content, the higher the elongation tends to be, and the Al alloy also has excellent elongation. However, if the amount of Nd is too small, strength and heat resistance decrease (Sample No. 103).

Here, the Al alloys of Sample No. 5 to No. 10, in which the Nd content was more than 0.001% by mass and less than 2.5% by mass, had a tensile strength of more than 200 MPa, and further 220 MPa or more, and a conductivity of 58% IACS or more. In addition, in these Al alloys, the average crystal grain size of the matrix was small (5 μm or less here), and the average major axis length of the Fe—Al compound was short (here, 200 nm or less, and further 150 nm or less). It can be said that such an Al alloy has the above-described specific structure, and it is considered that strength can be improved while having excellent conductivity.

Furthermore, the Al alloys of Sample No. 5 to No. 10 had a small average aspect ratio of the Fe—Al compound (less than 2.8 here), and an appropriate amount of the compound was present (here, the average density was 100 or more and 1500 or less). Such an above-described compound tends to be uniformly dispersed in the matrix, and thus it is considered that the strength of the Al alloy is likely to be improved.

On the other hand, in the Al alloy of Sample No. 103, which had too little Nd, it can be considered that the action by the Nd was insufficient. In the Al alloy of Sample No. 103, the average major axis length of the Fe—Al compound was 70 nm. Although a certain amount of the compound was present, the crystals were not uniformly dispersed in the matrix and were unevenly distributed and the like. It is considered that that as a result the crystals were larger, and the strength could not be sufficiently improved. In the Al alloy of Sample No. 104, which had too much Nd, an intermetallic compound of Nd and Al was formed, and it is considered that this intermetallic compound impaired the conductive path of Al, thereby reducing the conductivity. In addition, it is considered that the elongation was also reduced because the intermetallic compound served as the starting point of cracking.

From Tables 3 and 4, it can be said that the Nd content is preferably 0.002% by mass or more and 2% by mass or less. When the Nd content is 0.01% by mass or more and less than 1.0% by mass, particularly 0.01% by mass or more and 0.5% by mass or less (Sample No. 6 to No. 8), strength was high while having even better conductivity. Quantitatively, in Sample No. 6 to No. 8, the conductivity was 60% IACS or more, and the tensile strength at room temperature was 250 MPa or more. Further, in this case, the tensile strength at high temperature was 180 MPa or more, and further 190 MPa or more, and it can be said that heat resistance was also excellent. In addition, in this case, the elongation at break was 15% or more, and further 18% or more, and it can be said that elongation was also excellent.

(Content of Impurities)

As shown in Tables 5 and 6, in the case of Al alloys having the same composition, it can be seen that when the total content of impurities is small, strength is high and conductivity is also excellent (compare and refer to Table 3 and Sample No. 7 in Table 4). When the total content of impurities is too high (0.3% by mass here), one of the reasons for the decrease in strength may be that a compound including the impurity element and Al is formed (precipitated). The hardness of the compound including the impurity is lower than the hardness of the compound including Al and Fe, and it is considered that it is difficult to obtain the effect of an improvement in strength by dispersion strengthening. When the total content of impurities is too large, one of the reasons why the conductivity decreases is considered to be that the impurity element dissolves in the Al.

From Tables 5 and 6, it can be said that the total content of impurities is preferably 0.3% by mass or less, and particularly 0.1% by mass or less. When this total content is 0.1% by mass or less, the conductivity is 60% IACS or more, the tensile strength at room temperature is 250 MPa, the elongation at break is 15% or more, and the toughness is excellent while having excellent conductivity and high strength. Further, the tensile strength at high temperature is 180 MPa or more, and the heat resistance is also excellent.

(Crystal Grain Size of Matrix)

As shown in Tables 7 and 8, in the case of Al alloys having the same composition, it can be seen that the smaller the crystal grains constituting the matrix of the Al alloy, the better the strength and heat resistance. Further, it can be seen that the smaller the crystal grains, the finer the Fe—Al compound and the more the abundance tends to increase. From these facts, it can be considered that the smaller the crystal grains are, the easier it is to obtain the effect of an improvement in strength by strengthening of the grain boundaries of the crystals and the effect of an improvement in strength by dispersion strengthening of the compound, and that strength and heat resistance are improved. On the other hand, it can be said that the smaller the crystal grains, the more the conductivity tends to decrease. It is considered that one of the reasons for this is that the increase in the amount of compound makes it more likely that the conductive path of Al is impaired. In addition, it can be said that elongation also tends to decrease as the abundance of the compound increases.

From Tables 7 and 8, it can be said that the average crystal grain size of the matrix is preferably more than 0.09 μm and less than 5.5 μm, and particularly 0.1 μm or more and 5.0 μm or less. When the average crystal grain size is 0.3 μm or more and 1.5 μm or less, the conductivity is 60% IACS or more, the tensile strength at room temperature is 250 MPa, the elongation at break is 15% or more, and the toughness is excellent while having excellent conductivity and high strength. Further, the tensile strength at high temperature is 170 MPa or more, and the heat resistance is also excellent.

In Sample No. 13 to No. 19 shown in Table 7, one or more conditions selected from the group consisting of extrusion temperature (° C.), extrusion pressure (GPa), and heating temperature of the heat treatment (° C.) is different from Sample No. 7 shown in Table 3. Here, it can be said that the lower the heating temperature of the heat treatment, the smaller the crystal grains tend to be (Table 8).

In Sample No. 13 to No. 16, in which the extrusion temperature and the heating temperature of the heat treatment were lower than 400° C., there were a large amount of fine Fe—Al compounds and the crystal grains were fine. It is considered that the reason for this is, compared with Sample No. 7, because the extrusion temperature and the heating temperature were lower, the compound was more likely to precipitate finely and in a larger amount, and was less likely to grow. In Sample No. 7 to No. 19, in which the heating temperature of the heat treatment was constant at 400° C., and the extrusion temperature before the heat treatment was higher than in Sample No. 7, the compound was large, the crystal grains were large, and the abundance of the compound was low. It is considered that the reason for this is that the number of the compound decreased due to, for example, the compound coalescing during the heat treatment.

(Average Major Axis Length of Compound)

As shown in Tables 9 and 10, in the case of Al alloys having the same composition, it can be seen that the shorter the major axis length of the Fe—Al compound and the finer the Fe—Al compound is, the better the strength and heat resistance are. It can also be seen that the shorter the major axis length, the greater the abundance of the compound tends to be. From these facts, it is considered that the finer the compound is, the easier it is to obtain the effect of an improvement in strength by dispersion strengthening of the compound, and strength and heat resistance are improved. Furthermore, it can be seen that the shorter the major axis length, the finer the crystal grains constituting the matrix. It is considered that strength and heat resistance are improved because the fine crystal grains make it easier to obtain the effect of an improvement in strength by strengthening of the grain boundaries of the crystals.

From Tables 9 and 10, it can be said that the average major axis length of the Fe—Al compound is preferably less than 800 nm, and further 750 nm or less. When the average major axis length is 500 nm or less, the conductivity is 60% IACS or more, the tensile strength at room temperature is 250 MPa, the elongation at break is 15% or more, and the toughness is excellent while having excellent conductivity and high strength. Further, the tensile strength at high temperature is 180 MPa or more, and the heat resistance is also excellent.

In Sample No. 20 to No. 24 shown in Table 9, compared with Sample No. 7 shown in Table 3, the extrusion temperature is higher, the extrusion pressure is lower, and the heating temperature of the heat treatment is different. Here, it can be said that the lower the heating temperature of the heat treatment, the shorter the major axis length of the Fe—Al compound tends to be (Table 10). Even when the heating temperature of the heat treatment is lower than 400° C., if the extrusion temperature before the heat treatment is 400° C. or higher, it can be said that the major axis length of the compound tends to be longer, the crystal grains tend to be larger, and the abundance of the compound tends to be lower (Sample No. 20 to No. 23). It is considered that the reason for this is that the number of the compound decreased due to, for example, the compound coalescing during extrusion.

(Aspect Ratio of Compound)

As shown in Tables 11 and 12, in the case of Al alloys having the same composition, it can be seen that strength and heat resistance are better when the Fe—Al compound has a major axis length of 750 nm or less and a smaller aspect ratio. Further, it can be seen that the smaller the aspect ratio, the greater the abundance of the compound tends to be, and the smaller the crystal grains constituting the matrix tend to be. From these facts, it is considered that the finer the compound is and the smaller the aspect ratio is, the easier it is for the compound to be uniformly dispersed in the matrix, the easier it is to obtain the effect of an improvement in strength by dispersion strengthening of the compound, and strength and heat resistance are improved. It is considered that strength and heat resistance are improved because the crystal grains of the matrix are small, which makes it easier to obtain the effect of an improvement in strength by strengthening of the grain boundaries of the crystals.

It can also be seen that the finer the Fe—Al compound is and the smaller the aspect ratio is, the better the conductivity. One of the reasons for this is considered to be the fact that the compound does not easily impair the conductive path of the Al.

From Tables 11 and 12, it can be said that the average aspect ratio of the Fe—Al compound is preferably less than 4.1, and further 3.5 nm or less. When the average aspect ratio is 2.5 or less, the conductivity is 60% IACS or more, the tensile strength at room temperature is 250 MPa, the elongation at break is 15% or more, and the toughness is excellent while having excellent conductivity and high strength. Further, the tensile strength at high temperature is 180 MPa or more, and the heat resistance is also excellent.

In Sample No. 25 to No. 29 shown in Table 11, compared with Sample No. 7 shown in Table 3, the extrusion pressure is higher and the heating temperature of the heat treatment is different. Here, it can be said that the lower the heating temperature of the heat treatment, the smaller the aspect ratio of the Fe—Al compound tends to be (Table 12). Further, even when the extrusion temperature was the same as in Sample No. 7 but the heating temperature of the heat treatment was lower, if the extrusion pressure is high, it can be said that the major axis length of the compound tends to be longer and the crystal grains tend to be larger (Sample No. 25). The reason for this is considered to be because the heat of working increased due to the large extrusion pressure. In addition, in Sample No. 25, although the compound grew to some extent, it is considered that because the abundance of the compound was large, the tensile strength was higher than that in Sample No. 7.

(Abundance of Compound)

As shown in Tables 13 and 14, in the case of Al alloys having the same composition, it can be seen that strength and heat resistance are better when the abundance of the Fe—Al compound is large even though the major axis length is 750 nm or less. Further, it can be seen that the greater the average number of the compound, the smaller the crystal grains constituting the matrix tend to be. From these facts, it is considered that the finer the compound is and the smaller the average number is, the easier it is to obtain the effect of an improvement in strength by dispersion strengthening of the compound, and strength and heat resistance are improved. It is considered that strength and heat resistance are improved because the crystal grains are small, which makes it easier to obtain the effect of an improvement in strength by strengthening of the grain boundaries of the crystals.

On the other hand, if the average number of the Fe—Al compound is too large, conductivity is low. One of the reasons for this is considered to be the fact that the compound is more likely to impair the conductive path of the Al. Further, it can be said that the elongation tends to decrease as the abundance of the compound increases (Sample No. 30 and No. 31).

From Tables 13 and 14, it can be said that the average number of the Fe—Al compound is preferably more than 80 and less than 6200, and particularly 100 or more and 5000 or less. When the average number is 400 or more and 3000 or less, the conductivity is 60% IACS or more, the tensile strength at room temperature is 250 MPa, the elongation at break is 15% or more, and the toughness is excellent while having excellent conductivity and high strength. Further, the tensile strength at high temperature is 180 MPa or more, and the heat resistance is also excellent.

In Sample No. 30 to No. 36 shown in Table 13, compared with Sample No. 7 shown in Table 3, the extrusion temperature is lower, the extrusion pressure is higher, and the heating temperature of the heat treatment is different. Here, it can be said that the lower the heating temperature of the heat treatment, the greater the average number of the Fe—Al compound tends to be (Table 14). Further, in Sample No. 30 to No. 33, in which the extrusion temperature and the heating temperature of the heat treatment were lower than 400° C., there were a lot of the compounds and the crystal grains were fine. The reason for this is considered to be the same as for Sample No. 13 and the like described above. Even if the extrusion temperature is lower than 400° C., if the heating temperature of the heat treatment is 400° C. or higher, it can be said that the compound and the crystal grains tend to be large, and the abundance of the compound tends to decrease (Sample No. 34 to No. 36). The reason for this is considered to be that, in addition to the high heating temperature of the heat treatment, the heat of the working increased due to the high extrusion pressure. In addition, in Sample No. 36, in which the compound was relatively large and the abundance of the compound was low, for example, compared with Sample No. 33, it is considered that it was more difficult to obtain the effect of an improvement in strength by dispersion strengthening of the compound.

(Summary)

From the above, it was shown that an Al alloy having a composition including 0.1% by mass or more and 2.8% by mass or less of Fe and 0.002% by mass or more and 2% by mass or less of Nd has high strength while having excellent conductivity. In particular, the Al alloy tends to have high conductivity and high tensile strength when it has the above-described specific structure.

It was also shown that an Al alloy having high strength while having excellent conductivity can be produced by heat treating a material composed of the Al alloy having the above-described composition. In this test, the following can be further said.

(1) When the cooling rate of the molten metal is set extremely high in order to form a thin band or the like, a supersaturated solid solution is obtained, and the crystals constituting the matrix of the solidified material (thin strip material) tend to be fine. As a result, in the Al alloy obtained after the heat treatment, the Fe—Al compound tends to be fine, and the crystals constituting the matrix also tend to be fine. Here, in many samples, the average major axis length of the compound was 750 nm or less, and the average crystal grain size was 5 μm or less.

(2) When the heating temperature of the heat treatment was 500° C. or lower, the compound tended to be dispersed as fine particles.

The present invention is not limited to these examples. The present invention is defined by the scope of the claims, and it is intended that all modifications within the meaning and scope equivalent to the claims be included.

For example, in Test Example 1, the Fe content, the Nd content, the type of plastic working, the production conditions (cooling rate of the molten metal, hot pressing conditions, extrusion conditions, heat treatment conditions, and the like) can be modified as appropriate. For example, if wire drawing is carried out after extrusion and before the heat treatment, an Al alloy wire can be obtained.

### REFERENCE SIGNS LIST

1 particle composed of Fe—Al compound
P1, P2 parallel lines
L1 maximum length (major axis length)
L2 minor axis length

1. An aluminum alloy having a composition including:
0.1% by mass or more and 2.8% by mass or less of Fe; and
0.002% by mass or more and 2% by mass or less of Nd.

2. An aluminum alloy according to claim 1, wherein
the aluminum alloy has a composition including:
0.1% by mass or more and 2.8% by mass or less of Fe; and
0.002% by mass or more and 2% by mass or less of Nd,
with the balance being Al and unavoidable impurities.

3. The aluminum alloy according to claim 1, wherein a content of Fe in the composition is 0.1% by mass or more and 2.4% by mass or less.

4. The aluminum alloy according to claim 1, wherein a content of Nd in the composition is 0.01% by mass or more and 0.5% by mass or less.

5. The aluminum alloy according to claim 1, wherein
the aluminum alloy has a structure including a matrix and a compound,
the matrix is a metal phase mainly composed of Al,
the compound is a compound including Al and Fe, and
in any cross section, the matrix has an average grain size of 0.1 μm or more and 5 μm or less.

6. The aluminum alloy according to claim 5, wherein the average grain size is 0.3 μm or more and 5 μm or less.

7. The aluminum alloy according to claim 1, wherein
the aluminum alloy has a structure including a matrix and a compound,
the matrix is a metal phase mainly composed of Al,
the compound is a compound including Al and Fe, and
in any cross section, the compound has an average major axis length of 750 nm or less.

8. The aluminum alloy according to claim 7, wherein the average major axis length is 500 nm or less.

9. The aluminum alloy according to claim 7, wherein the compound has an average aspect ratio of 3.5 or less.

10. The aluminum alloy according to claim 9, wherein the average aspect ratio is 2.5 or less.

11. The aluminum alloy according to claim 7, wherein in any cross section, in a square measurement area with sides of 5 μm, an average number of the compound present in the measurement area is 100 or more and 5000 or less.

12. The aluminum alloy according to claim 5, wherein Nd satisfies at least one of being in solid solution in the compound and being present at a grain boundary between a crystal of the matrix and the compound.

13. The aluminum alloy according to claim 1, wherein
a conductivity at room temperature is 58% IACS or more,
a tension strength at room temperature is more than 200 MPa,
an elongation at break at room temperature is 7.5% or more.

14. The aluminum alloy according to claim 13, wherein a tensile strength at 150° C. is 150 MPa or more.

15. An aluminum alloy wire made of the aluminum alloy according to claim 1.

16. The aluminum alloy wire according to claim 15, wherein a wire diameter is 0.1 mm or more and 5 mm or less.

17. A method for producing an aluminum alloy, comprising:
producing a material composed of an aluminum alloy including of 0.1% by mass or more and 2.8% by mass or less of Fe and 0.002% by mass or more and 2% by mass or less of Nd; and
heat treating the material.

18. The method for producing an aluminum alloy according to claim 17, wherein producing the material includes producing a thin strip material or a powder by quenching a molten metal composed of the aluminum alloy at a cooling rate of 10,000° C./sec or more.
